(19) United States
(12) Patent Application Publication
(10) Pub. No.: US 2011/0195262 A1
(43) Pub. Date: Aug. 11, 2011

(54) METHOD FOR FORMING A MULTILAYER PAINT FILM

(76) Inventor: Takato Adachi, Kanagawa (JP)

(21) Appl. No.: 13/125,121

(22) PCT Filed: Oct. 21, 2009
(86) PCT No.: PCT/JP2009/068141

§ 371 Date: Apr. 20, 2011

(30) Foreign Application Priority Data
Oct. 21, 2008 (JP) 2008-271436

(51) Int. Cl. B05D 3/02; C09D 161/28; C09D 167/04; C08K 5/29; B32B 27/34

(52) U.S. Cl. 428/473.5; 427/385.5; 524/195

(57) ABSTRACT

An object of the present invention is to provide a method of forming a multilayer coating film having excellent smoothness, distinctness of image, water resistance and chipping resistance. The present invention provides a method of forming a multilayer coating film by successively applying an aqueous intermediate coating composition, an aqueous base coating composition and a clear coating composition to a substrate; and simultaneously heat-curing the resulting intermediate coating, base coating, and clear coating, wherein the aqueous intermediate coating composition comprises as a resin component a hydroxy- and carboxy-containing polyester resin (A) having a hydroxy value in the range of 60 to 200 mgKOH/g, an acid value in the range of 10 to 60 mgKOH/g, and a number average molecular weight in the range of 700 to 5,000; a melamine resin (B) having a weight average molecular weight in the range of 500 to 4,000; and a polycarbodiimide compound (C).

### TECHNICAL FIELD

The present invention relates to a method of forming a multilayer coating film having excellent appearance, by a 3-coat-1-bake process comprising successively applying an aqueous intermediate coating composition, an aqueous base coating composition, and a clear coating composition to a substrate, and heat-curing the resulting three layers simultaneously to form a multilayer coating film.

### BACKGROUND ART

A method of forming a multilayer coating film by a 3-coat-2-bake (3C2B) process is widely used as a method of forming a coating film on automobile bodies. This method comprises the following steps after applying an electrodeposition coating composition to a substrate: application of an intermediate coating composition→curing by baking→application of a base coating composition→preheating (preliminary heating)→application of a clear coating composition→curing by baking. However, in recent years, for the purpose of saving energy, attempts have been made to omit the bake-curing step that is performed after applying the intermediate coating composition and use a 3-coat-1-bake (3C1B) process comprising the following steps after applying an electrodeposition coating composition to a substrate: application of an intermediate coating composition→preheating (preliminary heating)→application of a base coating composition→preheating (preliminary heating)→application of a clear coating composition→curing by baking.

From the viewpoint of controlling the environmental pollution caused by the vaporization of organic solvents, the establishment of a 3-coat-1-bake process using aqueous coating compositions as the intermediate coating composition and the base coating composition is particularly desired.

However, the 3-coat-1-bake process using an aqueous intermediate composition and an aqueous base coating composition has the following drawback due to the use of water as a main solvent in the composition. When an aqueous base coating composition is applied to an intermediate coating layer, the intermediate coating layer is dissolved by the water contained in the aqueous base coating composition, thus forming a mixed layer at the interface between the intermediate and base coating layers and resulting in a coating film having low smoothness, low distinctness of image and the like. Furthermore, because the aqueous intermediate coating composition and the aqueous base coating composition generally use a water soluble or water-dispersible film-forming resin, the resulting coating film may have insufficient water resistance, chipping resistance and the like.

To solve the above problem, Patent Literature 1 discloses a method of forming a multilayer coating film comprising successively applying an aqueous intermediate coating composition to a substrate to form an intermediate coating layer thereon, applying an aqueous metallic base coating composition to the intermediate coating layer to form a metallic base coating layer thereon, and applying a clear coating composition to the base coating layer to form a clear coating layer thereon. Patent Literature 1 describes that when the aqueous intermediate coating composition and/or the aqueous metallic base coating composition contains a polycarbodiimide compound and a carboxy-containing aqueous resin, the resulting multilayer coating film has excellent resistance to discoloration after water immersion and high distinctness of image. However, the coating film obtained by the method disclosed in Patent Literature 1 has insufficient smoothness, adhesion after water immersion and chipping resistance.

Patent Literature 2 discloses a method of forming a multilayer coating film by a 3C1B process using an aqueous intermediate coating composition (A), an aqueous base coating composition (B), and a clear coating composition (C). Patent Literature 2 describes that a multilayer coating film having excellent smoothness, distinctness of image, chipping resistance, and water resistance can be produced when the aqueous intermediate coating composition (A) contains a polyester resin (X) and a curing agent (Y), and the polyester resin (X) contains a benzene ring and a cyclohexane ring in an amount of 1.0 to 2.2 mol/kg (resin solids content) in total; and that the curing agent (Y) is at least one compound selected from the group consisting of isocyanate group-containing compounds (a), oxazoline group-containing compounds (b), carbodiimide group-containing compounds (c), hydrazide group-containing compounds (d), and semicarbazide group-containing compounds (e). However, even when the method disclosed in Patent Literature 2 is used, the resulting multilayer coating film may be insufficient in terms of smoothness, distinctness of image, water resistance and chipping resistance.

### CITATION LIST

### Patent Literature

PTL 1: Japanese Unexamined Patent Publication No. 2001-9357
PTL 2: WO2007/126107

### SUMMARY OF INVENTION

### Technical Problem

An object of the present invention is to provide a method of forming a multilayer coating film having excellent smoothness, distinctness of image, adhesion after water immersion and chipping resistance by a 3-coat-1-bake process comprising successively applying an aqueous intermediate coating composition, an aqueous base coating composition, and a clear coating composition to a substrate, and simultaneously heat-curing the resulting three layers to form a multilayer coating film.

### Solution to Problem

To achieve the above object, the present inventors carried out extensive research. As a result, the inventors found that the above object can be achieved by a 3-coat-1-bake process comprising successively applying an aqueous intermediate coating composition, an aqueous base coating composition, and a clear coating composition to a substrate, and simultaneously heat-curing the resulting three layers to form a multilayer coating film, while using, as the intermediate coating composition, a coating composition comprising a hydroxy- and carboxy-containing polyester resin having a specific hydroxy value, a specific acid value and a specific number average molecular weight; a melamine resin having a specific weight average molecular weight; and a polycarbodiimide compound. The present invention has been accomplished based on this finding.

The present invention provides a method of forming a multilayer coating film, an aqueous coating composition used in the method, and an article having a multilayer coating film formed thereon by the method, as itemized below.

Item 1. A method of forming a multilayer coating film comprising the steps of:

(1) applying an aqueous intermediate coating composition (X) to a substrate to form an intermediate coating layer thereon;

(2) applying an aqueous base coating composition (Y) to the uncured intermediate coating layer formed in step (1) to form a base coating layer thereon;

(3) applying a clear coating composition (Z) to the uncured base coating layer formed in step (2) to form a clear coating layer thereon; and

(4) simultaneously heat-curing the uncured intermediate coating, uncured base coating, and uncured clear coating layers formed in steps (1) to (3),

the aqueous intermediate coating composition (X) comprising: as a resin component;

a hydroxy- and carboxy-containing polyester resin (A) having a hydroxy value in the range of 60 to 200 mgKOH/g, an acid value in the range of 10 to 60 mgKOH/g, and a number average molecular weight in the range of 700 to 5,000; a melamine resin (B) having a weight average molecular weight in the range of 500 to 4,000; and a polycarbodiimide compound (C).

Item 2. The method of forming a multilayer coating film according to item 1 wherein the hydroxy- and carboxy-containing polyester resin (A) is a polyester resin containing a C₄ or higher linear alkylene group in an amount of 0.3 to 2.5 mol/kg (on a resin solids basis).

Item 3. The method of forming a multilayer coating film according to item 1 or 2 wherein the hydroxy- and carboxy-containing polyester resin (A) contains a benzene ring and/or a cyclohexane ring in such an amount that the total amount of benzene ring and cyclohexane ring is in the range of 1.5 to 4.0 mol/kg (on a resin solids basis).

Item 4. The method of forming a multilayer coating film according to any one of items 1 to 3 wherein the melamine resin (B) is a methyl-butyl mixed etherified melamine resin having a methoxy/butoxy molar ratio in the range of 95/5 to 5/95.

Item 5. The method of foaming a multilayer coating film according to any one of items 1 to 4 wherein the aqueous intermediate coating composition (X) contains a hydroxy- and carboxy-containing polyester resin (A), a melamine resin (B), and a polycarbodiimide compound (C) in such proportions that the amount of hydroxy- and carboxy-containing polyester resin (A) is 5 to 95 parts by mass, the amount of melamine resin (B) is 2 to 60 parts by mass, and the amount of polycarbodiimide compound (C) is 2 to 60 parts by mass, per 100 parts by mass of the total amount of hydroxy- and carboxy-containing polyester resin (A), melamine resin (B) and polycarbodiimide compound (C), on a solids basis.

Item 6. The method of forming a multilayer coating film according to any one of items 1 to 5 wherein the aqueous intermediate coating composition (X) contains a coloring pigment (D1) and/or an extender pigment (D2) in such an amount that the total amount of coloring pigment (D1) and extender pigment (D2) is in the range of 40 to 300 parts by mass, per 100 parts by mass of the total amount of hydroxy- and carboxy-containing polyester resin (A), melamine resin (B) and polycarbodiimide compound (C), on a solids basis.

Item 7. The method of forming a multilayer coating film according to item 1 wherein the aqueous intermediate coating composition (X) further contains an acrylic resin.

Item 8. The method of forming a multilayer coating film according to any one of items 1 to 6 wherein the aqueous base coating composition (Y) comprises a luster pigment (D3).

Item 9. The method of forming a multilayer coating film according to any one of items 1 to 7 wherein the substrate is a vehicle body having an undercoating layer formed thereon using an electrodeposition coating composition.

Item 10. An aqueous intermediate coating composition comprising a hydroxy- and carboxy-containing polyester resin (A) having a hydroxy value in the range of 60 to 200 mgKOH/g, an acid value in the range of 10 to 60 mgKOH/g, and a number average molecular weight in the range of 700 to 5,000, a melamine resin (B) having a weight average molecular weight in the range of 500 to 4,000, and a polycarbodiimide compound (C).

Item 11. The aqueous intermediate coating composition according to item 10 which is used as the aqueous intermediate coating composition (X) in the method of forming a multilayer coating film according to any one of items 1 to 9.

Item 12. An article having a multilayer coating film formed thereon by the method of any one of items 1 to 9.

### Advantageous Effects of Invention

According to the method of forming a coating film of the present invention, a multilayer coating film having excellent smoothness, distinctness of image, adhesion after water immersion and chipping resistance can be produced by a 3-coat-1-bake process comprising successively applying an aqueous intermediate coating composition, an aqueous base coating composition, and a clear coating composition to a substrate, and simultaneously heat-curing the resulting three layers to form a multilayer coating film. When using an aqueous base coating composition containing a luster pigment, a multilayer coating film having excellent appearance with a high flip-flop effect and little metallic mottling can be formed.

### DESCRIPTION OF EMBODIMENT

The method of forming a multilayer coating film of the present invention will be described below in more detail.

### Step (1)

According to the method of forming a multilayer coating film of the present invention, an aqueous intermediate coating composition (X) is applied to a substrate. The aqueous intermediate coating composition (X) comprises: a polyester resin (A) containing a hydroxy group and a carboxy group and having a hydroxy value of 60 to 200 mg KOH/g, an acid value of 10 to 60 mg KOH/g, and a number average molecular weight of 700 to 5,000; a melamine resin (B) having a weight average molecular weight of 500 to 4,000; and a polycarbodiimide compound (C).

In this specification, the acid value (mg KOH/g) is obtained by a potassium-hydroxide-based conversion (mg) of the amount of the acid group per gram (solids content) of a sample. The molecular weight of the potassium hydroxide is 56.1.

In this specification, the hydroxy value (mg KOH/g) is obtained by a potassium-hydroxide-based conversion (mg) of the amount of the hydroxy group per gram (solids content) of a sample. The molecular weight of the potassium hydroxide is 56.1.

In the present invention, the hydroxy value and acid value can be measured by the method disclosed in the Examples of this application.

### Substrate

The substrate to be coated with the aqueous intermediate coating composition (X) is not particularly limited. Examples of substrates include exterior panel parts of automobile bodies such as passenger cars, trucks, motorcycles, and buses; automotive components such as bumpers; exterior panel parts of household electric appliances such as cellular phones and audio equipment; etc. Among these substrates, exterior panel parts of automobile bodies and automotive components are preferable.

The material for the substrate is not particularly limited. Examples of the material include metallic materials such as iron, aluminum, brass, copper, tin, stainless steel, galvanized steel, steel plated with zinc alloys (Zn—Al, Zn—Ni, Zn—Fe, etc.); plastic materials such as polyethylene resins, polypropylene resins, acrylonitrile-butadiene-styrene (ABS) resins, polyamide resins, acrylic resins, vinylidene chloride resins, polycarbonate resins, polyurethane resins, epoxy resins, and like resins, mixtures of these resins, and various types of fiber-reinforced plastics (FRP); inorganic materials such as glass, cement, and concrete; wood; textile materials such as paper and cloth; etc. Among these materials, metallic materials and plastic materials are preferable.

The substrate may be a metal material or a metal body formed of a material as mentioned above, such as a vehicle body, which may be subjected to a surface treatment, such as phosphate treatment, chromate treatment, or composite oxide treatment, and which may be further coated thereon.

Examples of the substrate having a coating layer formed thereon include base materials whose surface is optionally treated and which have an undercoating layer formed thereon. Among these, vehicle bodies having an undercoating layer formed thereon using an electrodeposition coating composition are preferable, and those having an undercoating layer formed thereon using a cationic deposition coating composition are particularly preferable.

The substrate may be a plastic material as mentioned above or a plastic member formed therefrom, such as an automotive component (or part), which may have been surface-treated or coated with a primer, etc. The substrate may be a combination of the plastic and metallic materials mentioned above.

### Hydroxy- and Carboxy-Containing Polyester Resin (A)

The hydroxy- and carboxy-containing polyester resin (A) is a resin having one or more hydroxy groups and one or more carboxy groups per molecule. The hydroxy- and carboxy-containing polyester resin (A) has a hydroxy value of 60 to 200 mg KOH/g, an acid value of 10 to 60 mg KOH/g, and a number average molecular weight of 700 to 5,000.

The hydroxy- and carboxy-containing polyester resin (A) can be generally produced by an esterification or transesterification reaction of an acid component (a-1) with an alcohol component (a-2).

A compound that is typically used as an acid component to produce a polyester resin can be used as the acid component (a-1). Examples of the acid component (a-1) include an aliphatic polybasic acid (a-1-1), an alicyclic polybasic acid (a-1-2), an aromatic polybasic acid (a-1-3), and the like.

The aliphatic polybasic acid (a-1-1) is generally an aliphatic compound having two or more carboxy groups per molecule, an acid anhydride of the aliphatic compound, or an ester of the aliphatic compound. Examples of the aliphatic polybasic acid (a-1-1) include aliphatic polycarboxylic acids such as butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brasylic acid), hexadecanedioic acid, and octadecanedioic acid; anhydrides of these aliphatic polycarboxylic acids; lower alkyl esters of these aliphatic polycarboxylic acids; and the like. Such examples of the aliphatic polybasic acid (a-1-1) can be used singly or in a combination of two or more.

From the viewpoint of the smoothness, distinctness of image, water resistance, chipping resistance, etc., of the resulting coating film, it is preferable to use, as the aliphatic polybasic acid (a-1-1), an aliphatic dicarboxylic acid containing a C₄ or higher, preferably C₄₋₁₈, and more preferably C₄₋₁₂ linear alkyelene group. Examples of an aliphatic dicarboxylic acid containing a C₄ or higher linear alkylene group include hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brasylic acid), hexadecanedioic acid, and octadecanedioic acid; anhydrides of these aliphatic dicarboxylic acids; lower alkyl esters of these aliphatic dicarboxylic acids; and the like. Such compounds can be used singly or in a combination of two or more.

The alicyclic polybasic acid (a-1-2) is generally a compound having one or more alicyclic structures (mainly 4- to 6-membered rings) and two or more carboxy groups per molecule, an acid anhydride of the compound, or an ester of the compound. Examples of the alicyclic polybasic acid (a-1-2) include alicyclic polycarboxylic acids such as 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, and 1,3,5-cyclohexanetricarboxylic acid; anhydrides of these alicyclic polycarboxylic acids; lower alkyl esters of these alicyclic polycarboxylic acids; etc. Such examples of the alicyclic polybasic acid (a-1-2) can be used singly or in a combination of two or more.

It is particularly preferable to use, as the alicyclic polybasic acid (a-1-2), 1,2-cyclohexanedicarboxylic acid, 1,2-cyclohexanedicarboxylic acid anhydride, or 1,4-cyclohexanedicarboxylic acid.

The aromatic polybasic acid (a-1-3) is generally an aromatic compound having two or more carboxy groups per molecule, an acid anhydride of the aromatic compound, or an ester of the aromatic compound. Examples of the aromatic polybasic acid (a-1-3) include aromatic polycarboxylic acids such as phthalic acid, isophthalic acid, terephthalic acid, naphthalenedicarboxylic acid, 4,4′-biphenyldicarboxylic acid, trimellitic acid, and pyromellitic acid; anhydrides of these aromatic polycarboxylic acids; lower alkyl esters of these aromatic polycarboxylic acids; and the like. Such examples of the aromatic polybasic acid (a-1-3) can be used singly or in a combination of two or more.

It is particularly preferable to use, as the aromatic polybasic acid (a-1-3), phthalic acid, phthalic anhydride, isophthalic acid, trimellitic acid, or trimellitic anhydride.

Examples of the acid component (a-1) other than the aliphatic polybasic acid (a-1-1), alicyclic polybasic acid (a-1-2), and aromatic polybasic acid (a-1-3) include fatty acids such as palm oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, and safflower oil fatty acid; monocarboxylic acids such as lauric acid, myristic acid, palmitic acid, stearic acid, oleic acid, linolic acid, linolenic acid, benzoic acid, p-tert-butylbenzoic acid, cyclohexanoic acid, and 10-phenyloctadecanoic acid; hydroxycarboxylic acids such as lactic acid, citric acid, 3-hydroxybutanoic acid, and 3-hydroxy-4-ethoxybenzoic acid; and the like. Such examples of the acid component (a-1) can be used singly or in a combination of two or more.

A polyhydric alcohol having two or more hydroxy groups per molecule can be preferably used as the alcohol component (a-2). Examples of a polyhydric alcohol include an aliphatic diol (a-2-1), an alicyclic diol (a-2-2), an aromatic diol (a-2-3), and the like.

The aliphatic diol (a-2-1) is generally an aliphatic compound having two hydroxy groups per molecule. Examples of the aliphatic diol (a-2-1) include ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-1,5-pentanediol, 2,2,4-trimethyl-1,3-pentanediol, 1,6-hexanediol, 1,5-hexanediol, 1,4-hexanediol, 2,5-hexanediol, 1,9-nonanediol, 1,10-decanediol, 1,12-dodecanediol, neopentylglycol, and the like. Such compounds can be used singly or in a combination of two or more.

From the viewpoint of the smoothness, distinctness of image, chipping resistance, etc., of the resulting coating film, it is preferable to use, as the aliphatic diol (a-2-1), an aliphatic diol containing a C₄ or higher, preferably C₄₋₁₂/and more preferably C₆₋₁₀ linear alkylene group. Examples of an aliphatic diol containing a C₄ or higher linear alkylene group include 1,4-butanediol, 1,5-pentanediol, 1,6-hexanediol, 1,7-heptanediol, 1,8-octanediol, 1,9-nonanediol, etc. Such compounds can be used singly or in a combination of two or more.

The alicyclic diol (a-2-2) is generally a compound having one or more alicyclic structures (mainly 4- to 6-membered rings) and two hydroxy groups per molecule. Examples of the alicyclic diol (a-2-2) include dihydric alcohols such as 1,4-cyclohexane dimethanol, tricyclodecanedimethanol, hydrogenated bisphenol A, and hydrogenated bisphenol F; polylactone diols obtained by adding lactones, such as ε-caprolactone, to these dihydric alcohols; etc. Such compounds can be used singly or in a combination of two or more.

The aromatic diol (a-2-3) is generally an aromatic compound having two hydroxy groups per molecule. Examples of the aromatic diol (a-2-3) include ester diols such as bis(hydroxyethyl)terephthalate; alkylene oxide adducts of bisphenol A; and the like. Such compounds can be used singly or in a combination of two or more.

Examples of a polyhydric alcohol other than the aliphatic diol (a-2-1), alicyclic diol (a-2-2), and aromatic diol (a-2-3) include polyether diols such as polyethylene glycol, polypropylene glycol, and polybutylene glycol; trihydric or higher alcohols such as glycerol, trimethylolethane, trimethylolpropane, diglycerol, triglycerin, 1,2,6-hexanetriol, pentaerythritol, dipentaerythritol, tris(2-hydroxyethyl)isocyanurate, sorbitol, and mannite; polylactone polyols obtained by adding lactones, such as ε-caprolactone, to these trihydric or higher alcohols; and the like.

Examples of the alcohol component (a-2) other than the above polyhydric alcohols include monohydric alcohols such as methanol, ethanol, propyl alcohol, butyl alcohol, stearyl alcohol, and 2-phenoxyethanol; alcohol compounds obtained by reacting acids with monoepoxy compounds, such as propylene oxide, butylene oxide, and a glycidyl ester of a synthetic highly branched saturated fatty acid (trade name “Cardula E10”, produced by HEXION Specialty Chemicals); and the like.

From the viewpoint of the smoothness, distinctness of image, water resistance, chipping resistance, etc., of the resulting coating film, a polyester resin containing a C₄ or higher linear alkylene group in an amount of 0.3 to 2.5 mol/kg (on a resin solids basis), and more preferably 0.4 to 2.0 mol/kg (on a resin solids basis) is preferably used as the hydroxy- and carboxy-containing polyester resin (A).

The carboxy-containing polyester resin containing C₄ or higher linear alkylene groups can be produced, for example, by using an aliphatic dicarboxylic acid containing a C₄ or higher linear alkylene group as the acid component (a-1) or using an aliphatic diol containing a C₄ or higher linear alkylene group as the alcohol component (a-2).

The “amount of C₄ or higher linear alkylene group” as used herein refers to the number of moles of the C₄ or higher linear alkylene group contained per kg of the polyester resin (on a solids basis). This can be calculated by dividing the total mole number (Wm) of the C₄ or higher linear alkylene group-containing monomers used to produce a polyester resin by the mass (Wr, unit: kg) of the obtained resin excluding the mass of condensed water (i.e.; Wm/Wr).

The “amount of C₄ or higher linear alkylene group” can be controlled, for example, by adjusting the proportions of the C₄ or higher linear alkylene group-containing aliphatic dicarboxylic acid and C₄ or higher linear alkylene group-containing aliphatic diol in the acid component (a-1) and alcohol component (a-2).

From the viewpoint of the smoothness, distinctness of image, water resistance, chipping resistance, etc., of the resulting coating film, the hydroxy- and carboxy-containing polyester resin (A) preferably contains a benzene ring and/or a cyclohexane ring in such an amount that the total amount of benzene ring and cyclohexane ring is in the range of 1.5 to 4.0 mol/kg, and preferably 2.0 to 3.5 mol/kg (on a resin solids basis).

The hydroxy- and carboxy-containing polyester resin having a benzene ring and/or a cyclohexane ring can be produced, for example, by using, as the acid component (a-1) or alcohol component (a-2), at least one compound selected from the group consisting of an alicyclic polybasic acid (a-1-2), an aromatic polybasic acid (a-1-3), an alicyclic diol (a-2-2), and an aromatic diol (a-2-3), and performing an esterification or transesterification reaction.

The “total amount of benzene ring and cyclohexane ring”, as used herein, refers to the total mole number of the benzene ring and cyclohexane ring contained per kg of the polyester resin (on a solids basis). This can be calculated by dividing the total mole number (Wn) of the benzene ring-containing monomers and cyclohexane ring-containing monomers contained in monomers used to produce a polyester resin by the mass (Wr, unit: kg) of the obtained resin excluding the mass of condensed water (i.e., Wn/Wr). The “total amount of benzene ring and cyclohexane ring” can be controlled, for example, by adjusting the proportions of the alicyclic polybasic acid (a-1-2), aromatic polybasic acid (a-1-3), alicyclic diol (a-2-2), and aromatic diol (a-2-3) in the acid component (a-1) and alcohol component (a-2).

The method of producing the hydroxy- and carboxy-containing polyester resin (A) is not particularly limited, and may be a known method. For example, a method can be employed in which the acid component (a-1) is reacted with the alcohol component (a-2) in a nitrogen stream at 150 to 250° C. for 5 to 10 hours to perform an esterification or transesterification reaction.

In the esterification or transesterification reaction, the acid component (a-1) and the alcohol component (a-2) can be added at once or in divided portions. A carboxy-containing polyester resin may be first synthesized, and then part of the carboxy groups of the carboxy-containing polyester resin may be esterified with the alcohol component (a-2). Alternatively, a hydroxy-containing polyester resin may be first synthesized and then reacted with an acid anhydride to half-esterify the hydroxy-containing polyester resin.

In the esterification or transesterification reaction, a catalyst may be used to promote the reaction. Examples of a catalyst include dibutyltin oxide, antimony trioxide, zinc acetate, manganese acetate, cobalt acetate, calcium acetate, lead acetate, tetrabutyl titanate, tetraisopropyl titanate, and like known catalysts.

The hydroxy- and carboxy-containing polyester resin (A) can be modified with a fatty acid, a monoepoxy compound, a polyisocyanate compound, or the like during the preparation of the resin or after the esterification or transesterification reaction.

Examples of a fatty acid include palm oil fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, safflower oil fatty acid, and the like. Preferable examples of the monoepoxy compound include a glycidyl ester of a synthetic highly branched saturated fatty acid (trade name “Cardura E10”, produced by HEXION Specialty Chemicals).

Examples of a polyisocyanate compound include aliphatic diisocyanates such as lysine diisocyanate, hexamethylene diisocyanate, and trimethylhexane diisocyanate; alicyclic diisocyanates such as hydrogenated xylylene diisocyanate, isophorone diisocyanate, methylcyclohexane-2,4-diisocyanate, methylcyclohexane-2,6-diisocyanate, 4,4′-methylenebis(cyclohexylisocyanate), and 1,3-(isocyanatomethyl)cyclohexane; aromatic diisocyanates such as tolylene diisocyanate, xylylene diisocyanate, and diphenylmethane diisocyanate; organic polyisocyanates such as lysine triisocyanate and like tri- or higher polyisocyanates; adducts of such organic polyisocyanates with polyhydric alcohols, low-molecular-weight polyester resins, water or the like; cyclopolymers (e.g., isocyanurates), biuret-type adducts, etc., of such organic diisocyanates; and the like. Such compounds can be used singly or in a combination of two or more.

From the viewpoint of the water resistance, chipping resistance, etc., of the resulting multilayer coating film, the hydroxy- and carboxy-containing polyester resin (A) preferably has a hydroxy value of about 60 to about 200 mg KOH/g, preferably about 80 to about 180 mg KOH/g, and more preferably about 100 to about 160 mg KOH/g.

From the viewpoint of the smoothness, distinctness of image, water resistance, etc., of the resulting multilayer coating film, the hydroxy- and carboxy-containing polyester resin (A) preferably has an acid value of about 10 to about 60 mg KOH/g, preferably about 15 to about 50 mg KOH/g, and more preferably about 20 to about 40 mg KOH/g.

The hydroxy value and acid value of the hydroxy- and carboxy-containing polyester resin (A) can be controlled, for example, by adjusting the proportions of the acid component (a-1) and alcohol component (a-2), or adjusting the reaction temperature or reaction time of the esterification or transesterification reaction.

From the viewpoint of the smoothness, distinctness of image, water resistance, etc., of the resulting multilayer coating film, the hydroxy- and carboxy-containing polyester resin (A) preferably has a number average molecular weight of about 700 to about 5,000, preferably about 900 to about 2,500, and more preferably about 1,100 to about 1,800.

The number average molecular weight of the hydroxy- and carboxy-containing polyester resin (A) can be controlled, for example, by adjusting the reaction temperature or reaction time of the esterification or transesterification reaction.

The number average molecular weight and weight average molecular weight as used herein are determined by converting the number average molecular weight and the weight average molecular weight measured using a gel permeation chromatograph (GPC), based on the molecular weight of polystyrene standards. More specifically, they can be measured using an “HLC-8120GPC” gel permutation chromatography apparatus (trade name, produced by Tosoh Corporation), together with four columns: “TSKgel G-4000 HXL”, “TSKgel G-3000 HXL”, “TSKgel G-2500 HXL”, and “TSKgel G-2000 HXL” (trade names, produced by Tosoh Corporation) under the following conditions.

Mobile phase: tetrahydrofuran
Measurement temperature: 40° C.
Flow rate: 1 mL/min

### Detector: RI

The hydroxy- and carboxy-containing polyester resin (A) can be made water soluble or water dispersible by neutralizing the carboxy group in the molecule with a basic compound. Examples of a basic compound include hydroxides of alkali metals or alkaline earth metals such as sodium hydroxide, potassium hydroxide, lithium hydroxide, calcium hydroxide, and barium hydroxide; ammonia; primary monoamines such as ethylamine, propylamine, butylamine, benzylamine, monoethanolamine, neopentanolamine, 2-aminopropanol, 2-amino-2-methyl-1-propanol, and 3-aminopropanol; secondary monoamines such as diethylamine, diethanolamine, di-n-propanolamine, di-iso-propanolamine, N-methylethanolamine, and N-ethylethanolamine; tertiary monoamines such as dimethylethanolamine, trimethylamine, triethylamine, triisopropylamine, methyldiethanolamine, and 2-(dimethylamino)ethanol; polyamines such as diethylenetriamine, hydroxyethylaminoethylamine, ethylaminoethylamine, and methylaminopropylamine; etc.

From the viewpoint of the water resistance and other properties of the resulting coating film, the amount of basic compound is preferably about 0.1 to about 1.5 equivalents, and more preferably about 0.2 to about 1.2 equivalents, relative to the acid groups of the hydroxy- and carboxy-containing polyester resin (A).

### Melamine Resin (B)

The melamine resin (B) is a resin obtained by reacting melamine with aldehyde, and examples thereof include both partially and fully methylolated melamine resins. Moreover, the melamine resin (B) used as the intermediate coating composition (X) of the present invention preferably has a weight average molecular weight of generally 500 to 4,000, preferably 600 to 3,000, and more preferably 700 to 2,000, from the viewpoint of the smoothness, distinctness of image, water resistance, chipping resistance, etc., of the resulting multilayer coating film.

Examples of an aldehyde include formaldehyde, paraformaldehyde, acetaldehyde, benzaldehyde, and the like; particularly, formaldehyde is preferred. Also usable are products obtained by partially or fully etherifying, with suitable alcohols, the methylol groups of partially or fully methylolated amino resins. Examples of alcohols that can be used for etherification include methyl alcohol, ethyl alcohol, n-propyl alcohol, isopropyl alcohol, n-butyl alcohol, isobutyl alcohol, 2-ethyl-1-butanol, 2-ethyl-1-hexanol, and the like.

Examples of the melamine resin (B) preferably used include methyl-etherified melamine resins obtained by partially or fully etherifying, with methyl alcohol, methylol groups of partially or fully methylolated melamine resins; butyl-etherified melamine resins obtained by partially or fully etherifying, with butyl alcohol, methylol groups of partially or fully methylolated melamine resins; and methyl-butyl mixed etherified melamine resins obtained by partially or fully etherifying, with methyl alcohol and butyl alcohol, methylol groups of partially or fully methylolated melamine resins. Among these, butyl-etherified melamine resins and methyl-butyl mixed etherified melamine resins are preferable, and methyl-butyl mixed etherified melamine resins are particularly preferable, from the viewpoint of the smoothness, distinctness of image, water resistance, chipping resistance, etc., of the resulting multilayer coating film.

From the viewpoint of the smoothness, distinctness of image, water resistance, etc., of the resulting multilayer coating film, the methyl-butyl mixed etherified melamine resin preferably has a methoxy/butoxy molar ratio in the range of 95/5 to 5/95, preferably 85/15 to 25/75, and more preferably 75/25 to 55/45.

Commercially available products can be used as the melamine resin (B). Trade names of commercial products of such melamine resins include, for example, “Cymel 202”, “Cymel 203”, “Cymel 204”, “Cymel 211”, “Cymel 238”, “Cymel 251”, “Cymel 303”, “Cymel 323”, “Cymel 324”, “Cymel 325”, “Cymel 327”, “Cymel 350”, “Cymel 385”, “Cymel 1156”, “Cymel 1158”, “Cymel 1116”, and “Cymel 1130” (produced by Nihon Cytec Industries Inc.); and “U-Van 120”, “U-Van 20HS”, “U-Van 20SE60”, “U-Van 2021”, “U-Van 2028”, and “U-Van 28-60” (produced by Mitsui Chemicals, Inc.); and the like.

Such melamine resins (B) can be used singly or in a combination of two or more.

### Polycarbodiimide Compound (C)

A polycarbodiimide compound (C) is a compound having at least two carbodiimide groups per molecule. Examples of such compounds include those obtained by subjecting isocyanate groups of an isocyanate group-containing compound to a carbon dioxide removal reaction with each other.

From the viewpoint of the smoothness and other properties of the resulting coating film, it is preferable to use a water-soluble or water-dispersible polycarbodiimide compound as the polycarbodiimide compound (C). Any polycarbodiimide compound that can be stably dissolved or dispersed in an aqueous medium can be used as a water-soluble or water-dispersible polycarbodiimide compound.

Specific examples of a water-soluble polycarbodiimide compound include “Carbodilite SV-02”, “Carbodilite V-02”, “Carbodilite V-02-L2”, “Carbodilite V-04” (trade names, produced by Nisshinbo Industries, Inc.), and the like. Examples of a water-dispersible polycarbodiimide compound include “Carbodilite E-01”, “Carbodilite E-02” (trade names, produced by Nisshinbo Industries, Inc.), and the like.

Such polycarbodiimide compounds (C) can be used singly or in a combination of two or more.

### Aqueous Intermediate Coating Composition (X)

The aqueous intermediate coating composition (X) used in the method of forming a multilayer coating film of the present invention is an aqueous coating composition comprising the hydroxy- and carboxy-containing polyester resin (A), melamine resin (B), and polycarbodiimide compound (C).

The “aqueous coating composition” as used herein is a term used in contrast with an “organic solvent-based coating composition”, and generally means a coating composition produced by dispersing and/or dissolving a coating film-forming resin, a pigment, etc., in water or in a medium mainly consisting of water (an aqueous medium). The amount of water in the aqueous intermediate coating composition (X) is preferably about 10 to about 90 mass %, more preferably about 20 to about 80 mass %, and even more preferably about 30 to about 60 mass %.

The proportions of the hydroxy- and carboxy-containing polyester resin (A), melamine resin (B), and polycarbodiimide compound (C) in the aqueous intermediate coating composition (X) are preferably within the following ranges, based on 100 parts by mass of the total solids content of the hydroxy- and carboxy-containing polyester resin (A), melamine resin (B), and polycarbodiimide compound (C):

the amount of hydroxy- and carboxy-containing polyester resin (A) is 5 to 95 parts by mass, preferably 25 to 90 parts by mass, and more preferably 40 to 80 parts by mass;

the amount of melamine resin (B) is 2 to 60 parts by mass, preferably 5 to 50 parts by mass, and more preferably 10 to 40 parts by mass; and

the amount of polycarbodiimide compound (C) is 2 to 60 parts by mass, preferably 5 to 40 parts by mass, and more preferably 10 to 30 parts by mass.

A multilayer coating film with excellent smoothness, distinctness of image, adhesion after water immersion, and chipping resistance can be formed by using the aqueous intermediate coating composition (X) containing the hydroxy- and carboxy-containing polyester resin (A), the melamine resin (B), and the polycarbodiimide compound (C) in a 3-coat 1-bake process comprising successively applying an aqueous intermediate coating composition, an aqueous base coating composition, and a clear coating composition, and simultaneously heat-curing the resulting three coating layers to form a multilayer coating film. This is presumably for the following reason. The use of the hydroxy- and carboxy-containing polyester resin (A) having a relatively low molecular weight improves smoothness. Moreover, the use of the polycarbodiimide compound (C) as a crosslinking agent improves distinctness of image. Furthermore, the use of the melamine resin (B) having a specific molecular weight improves adhesion after water immersion and chipping resistance. More specifically, it is considered that from the time of applying the aqueous base coating composition to before the initiation of heat curing, mixture with the aqueous base coating composition is inhibited mainly by the increase of molecular weight by the crosslinking reaction of the carboxy groups of the hydroxy- and carboxy-containing polyester resin (A) with the polycarbodiimide compound (C); and in the subsequent heat-curing process, a network structure having a high crosslinking density and relatively uniform crosslinking points can be formed mainly by a crosslinking reaction of the hydroxy group of the hydroxy- and carboxy-containing polyester resin (A) with the melamine resin (B).

Generally, when a polyester resin having a low molecular weight is used as a resin for forming a coating film, the resulting coating composition easily flows, therefore producing a coating film having excellent smoothness on a horizontal plane; while sagging easily occurs and smoothness is easily decreased on a vertical plane. Particularly, in a 3-coat 1-bake process in which three layers of uncured coating films are applied one on top of the other, when a polyester resin having a low molecular weight was used in the aqueous intermediate coating composition of the undermost layer, sagging occurred because of the weight of the upper uncured coating films, and consequently, the smoothness of the resulting coating film was often decreased. Furthermore, when the polyester resin having a low molecular weight was used as a resin for forming a coating film, the film performance, such as adhesion after water immersion and chipping resistance, of the resulting coating film was often reduced. In contrast, it is therefore considered that the aqueous intermediate coating composition (X) used in the present invention, which contains the polyester resin (A) having two kinds of crosslinkable functional groups (i.e., a hydroxy group and a carboxy group), the melamine resin (B) reacting with each crosslinkable functional groups, and the polycarbodiimide compound (C), can form a network structure having a high crosslinking density and relatively uniform crosslinking points, therefore forming a coating film in which sagging hardly occurs and smoothness, adhesion after water immersion, and chipping resistance are excellent.

The aqueous intermediate coating composition (X) may contain, in addition to the hydroxy- and carboxy-containing polyester resin (A), a resin for modification. Examples of a resin for modification include water-soluble or water-dispersible polyurethane resins, acrylic resins, alkyd resins, polyester resins, silicon resins, fluororesins, epoxy resins, and the like. Particularly, the aqueous intermediate coating composition (X) preferably contains polyurethane resins, acrylic resins, etc., from the viewpoint of the water resistance, chipping resistance, etc., of the resulting coating film.

When the aqueous intermediate coating composition (X) contains such a resin for modification, the amount of the resin for modification, on a solids basis, is typically 1 to 100 parts by mass, preferably 10 to 70 parts by mass, and more preferably 15 to 50 parts by mass, per 100 parts by mass of the total amount of hydroxy- and carboxy-containing polyester resin (A), melamine resin (B), and polycarbodiimide compound (C), on a solids basis.

Examples of a polyurethane resin include a resin prepared as follows: a urethane prepolymer is produced by reacting at least one diol selected from the group consisting of polyether diols, polyester diols and polycarbonate diols, a low-molecular-weight polyhydroxy compound and dimethanol alkanoic acid with aliphatic and/or alicyclic diisocyanates; the urethane prepolymer is neutralized with a tertiary amine and emulsified and dispersed in water; and, if necessary, the resulting emulsion is mixed with an aqueous medium containing a chain extender such as a polyamine, a crosslinking agent, and/or a terminator, to perform a reaction until substantially no isocyanate group remains. The above method usually yields a self-emulsifiable polyurethane resin with a mean particle diameter of about 0.001 to about 3 μm. Examples of commercial products of the polyurethane resin include “U-Coat UX-5000” and “U-Coat UX-8100” (trade names, produced by Sanyo Chemical Industries, Ltd.), etc.

When the aqueous intermediate coating composition (X) contains a polyurethane resin as mentioned above, the amount of polyurethane resin, on a solids basis, is generally 1 to 100 parts by mass, preferably 10 to 70 parts by mass, and more preferably 15 to 50 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

The acrylic resin is not particularly limited. For example, a hydroxy-containing acrylic resin can be suitably used. The hydroxy-containing acrylic resin can be generally produced by copolymerizing a hydroxy-containing polymerizable unsaturated monomer and another polymerizable unsaturated monomer by, for example, a known method such as solution polymerization in an organic solvent and emulsion polymerization in water.

From the viewpoint of storage stability, the water resistance of the resulting coating film, etc., the hydroxy-containing acrylic resin preferably has a hydroxy value of 5 to 200 mg KOH/g, more preferably 15 to 180 mg KOH/g, and even more preferably 20 to 160 mg KOH/g.

When the acrylic resin has an acid group such as a carboxy group, the acrylic resin preferably has an acid value of 1 to 200 mg KOH/g, more preferably 2 to 100 mg KOH/g, and even more preferably 5 to 50 mg KOH/g, from the viewpoint of the water resistance and other properties of the resulting coating film.

From the viewpoint of the smoothness, water resistance, etc., of the resulting coating film, the acrylic resin preferably has a weight average molecular weight of about 2,000 to about 5,000,000, more preferably about 3,000 to about 3,000,000, and even more preferably about 4,000 to about 2,000,000.

When the aqueous intermediate coating composition (X) contains an acrylic resin as mentioned above, the amount of acrylic resin, on a solids basis, is generally 1 to 100 parts by mass, preferably 2 to 70 parts by mass, and more preferably 5 to 50 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

From the viewpoint of the smoothness and distinctness of image of the resulting multilayer coating film, it is preferable to use, as the acrylic resin, an acrylic resin obtained by polymerizing a monomer component comprising a polymerizable unsaturated monomer (g-1) having a O₄₋₂₄ alkyl group in an amount of 5 to 100 mass %, more preferably 30 to 95 mass %, and even more preferably 50 to 90 mass %, based on the total mass of the monomer component.

It is particularly preferable to use, as the acrylic resin, a hydroxy- and carboxy-containing acrylic resin (G) obtained by copolymerizing a monomer component (g) comprising a polymerizable unsaturated monomer (g-1) having a C₄₋₂₄ alkyl group, a hydroxy-containing polymerizable unsaturated monomer (g-2), and a carboxy-containing polymerizable unsaturated monomer (g-3), from the viewpoint of the smoothness, distinctness of image, and water resistance of the resulting multilayer coating film.

Examples of the polymerizable unsaturated monomer (g-1) having a C₄₋₂₄ alkyl group include monoester compounds of (meth)acrylic acid and monohydric alcohol having a C₄₋₂₄ alkyl group. Specific examples thereof include alkyl or cycloalkyl (meth)acrylates such as n-butyl (meth)acrylate, isobutyl (meth)acrylate, tert-butyl (meth)acrylate, pentyl (meth)acrylate, hexyl (meth)acrylate, octyl (meth)acrylate, 2-ethylhexyl (meth)acrylate, nonyl (meth)acrylate, dodecyl (meth)acrylate (lauryl (meth)acrylate), tridecyl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, isobornyl (meth)acrylate, adamanthyl (meth)acrylate, and tricyclodecanyl (meth)acrylate. These can be used singly or in a combination of two or more.

In this specification, “(meth)acrylate” means acrylate or methacrylate, and “(meth)acrylic acid” means acrylic acid or methacrylic acid. Additionally, “(meth)acryloyl” means acryloyl or methacryloyl, and “(meth)acrylamide” means “acrylamide or methacrylamide”.

From the viewpoint of the distinctness of image and water resistance of the resulting coating film, it is preferable to use, as the polymerizable unsaturated monomer (g-1) having a C₄₋₂₄ alkyl group, a polymerizable unsaturated monomer having a C₄₋₁₃ alkyl group, and more preferably a polymerizable unsaturated monomer having a C₄₋₈ alkyl group. It is particularly preferable to use n-butyl (meth)acrylate, 2-ethylhexyl (meth)acrylate, and the like.

Examples of the hydroxy-containing polymerizable unsaturated monomer (g-2) include 2-hydroxyethyl (meth)acrylate, 2-hydroxypropyl (meth)acrylate, 3-hydroxypropyl (meth)acrylate, 4-hydroxybutyl (meth)acrylate, and like monoesters of (meth)acrylates with C₂₋₈ dihydric alcohols, ε-caprolactone-modified products of these monoesters of (meth)acrylates with C₂₋₈ dihydric alcohols, N-hydroxymethyl (meth)acrylamide, allyl alcohol, and (meth)acrylates having hydroxy-terminated polyoxyethylene chains, and the like. These can be used singly or in a combination of two or more. It is particularly preferable to use 2-hydroxyethyl (meth)acrylate, 2-hydroxypropyl (meth)acrylate, 3-hydroxypropyl (meth)acrylate, 4-hydroxybutyl (meth)acrylate, and the like, from the viewpoint of the smoothness, distinctness of image, water resistance, etc., of the resulting coating film.

Examples of the carboxy-containing polymerizable unsaturated monomer (g-3) include (meth)acrylic acid, maleic acid, crotonic acid, β-carboxyethyl acrylate, etc. These can be used singly or in a combination of two or more. It is particularly preferable to use acrylic acid and methacrylic acid, from the viewpoint of the smoothness, distinctness of image, water resistance, etc., of the resulting coating film.

From the viewpoint of the smoothness, distinctness of image, and water resistance of the resulting coating film, the proportions of the polymerizable unsaturated monomer (g-1) having a C₄₋₂₄ alkyl group, hydroxy-containing polymerizable unsaturated monomer (g-2), and carboxy-containing polymerizable unsaturated monomer (g-3) in the monomer component (g) are preferably within the following ranges, based on the total mass of the monomer component (g):

the amount of polymerizable unsaturated monomer (g-1) having a C₄₋₂₄ alkyl group is 5 to 100 mass %, more preferably 30 to 95 mass %, and even more preferably 50 to 90 mass %;

the amount of hydroxy-containing polymerizable unsaturated monomer (g-2) is 0.5 to 40 mass %, more preferably 2 to 15 mass %, and even more preferably 5 to 10 mass %; and

the amount of carboxy-containing polymerizable unsaturated monomer (g-3) is 0.5 to 20 mass %, more preferably 2 to 15 mass %, and even more preferably 3 to 8 mass %.

The monomer component (g) may contain a polymerizable unsaturated monomer (g-4) other than the polymerizable unsaturated monomers (g-1) to (g-3). In this case, the monomer component (g) comprises the polymerizable unsaturated monomers (g-1) to (g-4).

Examples of the polymerizable unsaturated monomer (g-4) other than the polymerizable unsaturated monomers (g-1) to (g-3) include alkyl (meth)acrylates having a C₁₋₃ alkyl group, such as methyl (meth)acrylate, ethyl (meth)acrylate, n-propyl (meth)acrylate, and isopropyl (meth)acrylate; aromatic ring-containing polymerizable unsaturated monomers such as benzyl (meth)acrylate, styrene, α-methyl styrene, and vinyl toluene; polymerizable unsaturated monomers having an alkoxysilyl group, such as vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane; perfluoroalkyl (meth)acrylates such as perfluorobutylethyl (meth)acrylate and perfluorooctylethyl (meth)acrylate; polymerizable unsaturated monomers having fluorinated alkyl groups, such as fluoroolefins; polymerizable unsaturated monomers having photopolymerizable functional groups, such as a maleimide group; vinyl compounds such as N-vinylpyrrolidone, ethylene, butadiene, chloroprene, vinyl propionate, and vinyl acetate; polymerizable unsaturated monomers having at least two polymerizable unsaturated groups per molecule, such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-tris-hydroxymethylethane di(meth)acrylate, 1,1,1-tris-hydroxymethylethane tri(meth)acrylate, 1,1,1-tris-hydroxymethylpropane tri(meth)acrylate, triallyl isocyanurate, diallyl terephthalate, and divinylbenzene; nitrogen-containing polymerizable unsaturated monomers, such as (meth)acrylonitrile, (meth) acrylamide, N,N-dimethylaminoethyl (meth)acrylate, N,N-diethylaminoethyl (meth)acrylate, N,N-dimethylaminopropyl (meth)acrylamide, and amine adducts of glycidyl (meth)acrylate; epoxy-containing polymerizable unsaturated monomers, such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether; isocyanato-containing polymerizable unsaturated monomers, such as 2-isocyanatoethyl (meth)acrylate and m-isopropenyl-α,α-dimethylbenzyl isocyanate; (meth)acrylates having alkoxy-terminated polyoxyethylene chains; carbonyl group-containing polymerizable unsaturated monomers such as acrolein, diacetone acrylamide, diacetone methacrylamide, acetoacetoxylethyl methacrylate, formylstyrol, and vinyl alkyl ketones having 4 to 7 carbon atoms (e.g., vinyl methyl ketone, vinyl ethyl ketone, and vinyl butyl ketone); and the like.

These polymerizable unsaturated monomers can be used singly or in a combination of two or more.

The hydroxy- and carboxy-containing acrylic resin (G) can be produced by copolymerizing a monomer component (g) as described above by, for example, a known method such as solution polymerization in an organic solvent, emulsion polymerization in water, and miniemulsion polymerization in water.

From the viewpoint of the storage stability of the coating composition and the smoothness, distinctness of image, water resistance, etc., of the resulting coating film, the hydroxy- and carboxy-containing acrylic resin (G) preferably has an acid value of 2 to 150 mg KOH/g, preferably 5 to 100 mg KOH/g, and more preferably 10 to 50 mg KOH/g.

From the viewpoint of the water resistance and other properties of the resulting coating film, the hydroxy-containing acrylic resin (A1) preferably has a hydroxy value of 2 to 150 mg KOH/g, preferably 5 to 80 mg KOH/g, and more preferably 20 to 60 mg KOH/g.

From the viewpoint of improving the smoothness, distinctness of image, and water resistance of the resulting coating film, it is preferable to use, as the hydroxy- and carboxy-containing acrylic resin (G), a water-dispersible hydroxy- and carboxy-containing acrylic resin (G′) alone, or the water-dispersible hydroxy- and carboxy-containing acrylic resin (G′) and a water-soluble hydroxy- and carboxy-containing acrylic resin in combination.

For example, the water-dispersible hydroxy- and carboxy-containing acrylic resin (G′) can be prepared by subjecting the monomer component (g) to emulsion polymerization using a polymerization initiator in the presence of a surfactant.

Anionic surfactants and nonionic surfactants can be suitably used as the surfactant. Examples of anionic surfactants include sodium salts and ammonium salts of alkylsulfonic acids, alkylbenzenesulfonic acids, alkylphosphoric acids, etc. Examples of nonionic surfactants include polyoxyethylene oleyl ether, polyoxyethylene stearyl ether, polyoxyethylene lauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sorbitan monolaurate, sorbitan monostearate, sorbitan trioleate, polyoxyethylene sorbitan monolaurate, etc.

Other examples of usable surfactants include polyoxyalkylene-containing anionic surfactants that have an anionic group and a polyoxyalkylene group, such as a polyoxyethylene group and a polyoxypropylene group, per molecule; and reactive anionic surfactants that have an anionic group and a radically polymerizable unsaturated group per molecule.

The amount of surfactant is preferably about 0.1 to 15 mass %, more preferably about 0.5 to 10 mass %, and even more preferably about 1 to 5 mass %, based on the total mass of the monomers used.

Examples of polymerization initiators include organic peroxides such as benzoyl peroxide, octanoyl peroxide, lauroyl peroxide, stearoyl peroxide, cumene hydroperoxide, tert-butyl peroxide, di-tert-amyl peroxide, tert-butyl peroxylaurate, tert-butyl peroxyisopropylcarbonate, tert-butyl peroxyacetate, and diisopropylbenzene hydroperoxide; azo compounds such as azobisisobutyronitrile, azobis(2,4-dimethylvaleronitrile), azobis(2-methylpropionenitrile), azobis(2-methylbutyronitrile), 4,4′-azobis(4-cyanobutanoic acid), dimethyl azobis(2-methyl propionate), azobis[2-methyl-N-(2-hydroxyethyl)-propionamide], and azobis[2-methyl-N-[2-(1-hydroxy butyl)]-propionamide]; persulfates such as potassium persulfate, ammonium persulfate, and sodium persulfate; etc. Such polymerization initiators can be used singly or in a combination of two or more. Redox initiators prepared by combining a polymerization initiator as mentioned above with a reducing agent such as sugar, sodium formaldehyde sulfoxylate, iron complex, etc., may also be used.

The amount of polymerization initiator is generally preferably about 0.1 to 5 mass %, and more preferably about 0.2 to 3 mass %, based on the total mass of all of the monomers used. The method of adding the polymerization initiator is not particularly limited, and can be suitably selected according to the kind and amount of polymerization initiator used. For example, the polymerization initiator may be incorporated into a monomer component or an aqueous medium beforehand, or may be added dropwise or all at once at the time of polymerization.

The monomer component (g) may optionally contain chain transfer agents and other components. The monomer component (g) is preferably added dropwise as a monomer emulsion obtained by dispersing the monomer component (g) into an aqueous medium, although it may be added dropwise as is. In this case, the particle size of the monomer emulsion is not particularly limited.

The water-dispersible hydroxy- and carboxy-containing acrylic resin (G′) obtained in this manner generally has a mean particle diameter of about 10 to 1,000 nm, and preferably about 20 to 500 nm. In this specification, the mean particle diameter of the water-dispersible hydroxy- and carboxy-containing acrylic resin (G′) refers to a value obtained by measurement at 20° C. using a submicron particle size distribution analyzer after dilution with deionized water according to a usual method. For example, “COULTER N4” (trade name, produced by Beckman Coulter, Inc.) can be used as the submicron particle size distribution analyzer.

From the viewpoint of the smoothness, distinctness of image, water resistance, etc., of the resulting coating film, the acid value of the water-dispersible hydroxy- and carboxy-containing acrylic resin (G′) is preferably 2 to 150 mg KOH/g, more preferably 5 to 100 mg KOH/g, and even more preferably 10 to 50 mg KOH/g.

Additionally, from the viewpoint of the smoothness, distinctness of image, water resistance, etc., of the resulting coating film, the hydroxy value of the water-dispersible hydroxy- and carboxy-containing acrylic resin (G′) is preferably 2 to 150 mg KOH/g, more preferably 5 to 80 mg KOH/g, and even more preferably 20 to 60 mg KOH/g.

The aqueous intermediate coating composition (X) may further contain a polyisocyanate compound, a blocked polyisocyanate compound, etc.

The polyisocyanate compound is a compound having at least two isocyanate groups per molecule. Examples of the polyisocyanate compound include aliphatic diisocyanates such as hexamethylene diisocyanate, trimethylhexane diisocyanate, dimer acid diisocyanate, and lysine diisocyanate; alicyclic diisocyanates such as hydrogenated xylylene diisocyanate, cyclohexylene diisocyanate, and isophorone diisocyanate; aromatic diisocyanates such as tolylene diisocyanate, phenylene diisocyanate, 4,4′-diphenylmethane diisocyanate, xylylene diisocyanate, tetramethylxylylene diisocyanate, and naphthalene diisocyanate; trivalent or higher organic polyisocyanate compounds such as 2-isocyanatoethyl-2,6-diisocyanatocaproate, 3-isocyanatomethyl-1,6-hexamethylene diisocyanate, and 4-isocyanatomethyl-1,8-octamethylene diisocyanate (commonly referred to as triamino-nonane triisocyanate); dimers and trimers of such polyisocyanate compounds (e.g., biurets and isocyanurates); prepolymers obtained by urethanization reactions of such polyisocyanate compounds with polyhydric alcohols, low-molecular-weight polyester resins, or water, under conditions such that isocyanate groups are present in excess; and the like.

The blocked polyisocyanate compound is a compound having at least two isocyanate groups per molecule wherein the isocyanate groups are blocked by a blocking agent.

Examples of a blocking agent include phenol compounds such as phenol, cresol, xylenol, nitrophenol, ethylphenol, hydroxydiphenyl, butylphenol, isopropylphenol, nonylphenol, octylphenol, and methyl hydroxybenzonate; lactam compounds such as ε-caprolactam, δ-valerolactam, γ-butyrolactam, and β-propiolactam; aliphatic alcohol compounds such as methanol, ethanol, propyl alcohol, butyl alcohol, amyl alcohol, and lauryl alcohol; ether compounds such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol compounds such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime compounds such as formamide oxime, acetamide oxime, acetoxime, methyl ethyl ketoxime, diacetyl monoxime, benzophenone oxime, and cyclohexane oxime; active methylene compounds such as dimethyl malonate, diethyl malonate, ethyl acetoacetate, methyl acetoacetate, and acetylacetone; mercaptan compounds such as butyl mercaptan, t-butyl mercaptan, hexyl mercaptan, t-dodecyl mercaptan, 2-mercaptobenzothiazole, thiophenol, methylthiophenol, and ethylthiophenol; acid amide compounds such as acetanilide, acetanisidide, acetotoluide, acrylamide, methacrylamide, acetamide, stearamide, and benzamide; imide compounds such as succinimide, phthalimide, and maleinimide; amine compounds such as diphenylamine, phenylnaphthylamine, xylidine, N-phenylxylidine, carbazole, aniline, naphthylamine, butylamine, dibutylamine, and butylphenylamine; imidazole compounds such as imidazole and 2-ethylimidazole; urea compounds such as urea, thiourea, ethyleneurea, ethylenetiourea, and diphenylurea; carbamate compounds such as phenyl N-phenylcarbamate; imine compounds such as ethyleneimine and propyleneimine; sulfite compounds such as sodium bisulfite and potassium bisulfite; azole compounds; and the like. Examples of such azole compounds include pyrazole or pyrazole derivatives such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives such as imidazole, benzimidazole, 2-methylimidazole, 2-ethylimidazole, and 2-phenylimidazole; imidazoline derivatives such as 2-methylimidazoline and 2-phenylimidazoline; and the like.

The aqueous intermediate coating composition (X) preferably further contains a pigment (D). Examples of the pigment (D) include coloring pigments (D1), extender pigments (D2), luster pigments (D3), and the like. Such pigments can be used singly or in a combination of two or more.

When the aqueous intermediate coating composition (X) contains a pigment (D), the amount of pigment (D) in the aqueous intermediate coating composition (X) is generally 1 to 300 parts by mass, preferably 20 to 200 parts by mass, and more preferably 50 to 150 parts by mass, per 100 parts by mass of the total amount of hydroxy- and carboxy-containing polyester resin (A), melamine resin (B), and polycarbodiimide compound (C), on a solids basis.

It is particularly preferable that the aqueous intermediate coating composition (X) contain a coloring pigment (D1) and/or an extender pigment (D2) in such an amount that the total amount of coloring pigment (D1) and extender pigment (D2) is 40 to 300 parts by mass, preferably 50 to 200 parts by mass, and more preferably 60 to 150 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

Examples of the coloring pigment (D1) include titanium oxide, zinc flower, carbon black, molybdenum red, Prussian blue, cobalt blue, azo pigments, phthalocyanine pigments, quinacridone pigments, isoindoline pigments, threne pigments, perylene pigments, dioxazine pigments, diketopyrrolopyrrole pigments, and the like. Among these, titanium oxide and carbon black are preferable.

When the aqueous intermediate coating composition (X) contains a coloring pigment (D1) as described above, the amount of coloring pigment (D1) is typically 1 to 300 parts by mass, preferably 3 to 200 parts by mass, and more preferably 5 to 150 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

Examples of the extender pigment (D2) include clay, kaolin, barium sulfate, barium carbonate, calcium carbonate, talc, silica, alumina white, etc. Among these, barium sulfate and talc are preferable.

It is particularly preferable to use, as the extender pigment (D2), barium sulfate having a mean primary particle diameter of 1 μm or less, and more preferably 0.01 to 0.8 μm. The aqueous intermediate coating composition (X) containing such barium sulfate as the extender pigment (D2) can form a multilayer coating film that has an excellent appearance with excellent smoothness, and also with a high flip-flop effect and little metallic mottling, when the aqueous base coating composition (Y) described below contains a luster pigment (D3).

The mean primary particle diameter of barium sulfate as used herein is determined by observing barium sulfate using a scanning electron microscope and averaging the maximum diameters of 20 barium sulfate particles on a straight line drawn at random on the electron microscope photograph.

When the aqueous intermediate coating composition (X) contains an extender pigment (D2) as described above, the amount of extender pigment (D2) is typically 1 to 300 parts by mass, preferably 5 to 200 parts by mass, and more preferably 10 to 150 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

Examples of the luster pigment (D3) include aluminum (which may be vapor-deposited aluminum), copper, zinc, brass, nickel, aluminum oxide, mica, titanium oxide-coated or iron oxide-coated aluminum oxide, titanium oxide-coated or iron oxide-coated mica, glass flakes, holographic pigments, etc. Such luster pigments (D3) can be used singly or in a combination of two or more. Examples of an aluminum pigment include leafing aluminum pigments and non-leafing aluminum pigments. Any of the pigments can be used.

When the aqueous intermediate coating composition (X) contains a luster pigment (D3) as described above, the amount of luster pigment (D3) is typically 1 to 50 parts by mass, preferably 2 to 30 parts by mass, and even more preferably 3 to 20 parts by mass, per 100 parts by mass of the total amount of hydroxy- and carboxy-containing polyester resin (A), melamine resin (B), and polycarbodiimide compound (C) in the aqueous intermediate coating composition (X), on a solids basis.

From the viewpoint of improving the smoothness and distinctness of image, the aqueous intermediate coating composition (X) preferably further contains a hydrophobic solvent (E).

The hydrophobic solvent (E) is desirably an organic solvent of which a mass of 10 g or less dissolves in 100 g of water at 20° C., preferably 5 g or less, and more preferably 1 g or less. Examples of an organic solvent include hydrocarbon solvents such as rubber solvents, mineral spirits, toluene, xylene, and solvent naphtha; alcoholic solvents such as 1-hexanol, 1-octanol, 2-octanol, 2-ethyl-1-hexanol, 1-decanol, benzyl alcohol, ethylene glycol mono-2-ethylhexyl ether, propylene glycol mono-n-butyl ether, dipropylene glycol mono-n-butyl ether, tripropylene glycol mono-n-butyl ether, propylene glycol mono-2-ethylhexyl ether, and propylene glycol monophenyl ether; ester solvents such as n-butyl acetate, isobutyl acetate, isoamyl acetate, methylamyl acetate, and ethylene glycol monobutyl ether acetate; ketone solvents such as methyl isobutyl ketone, cyclohexanone, ethyl n-amyl ketone, and diisobutyl ketone; and the like. Such solvents can be used singly or in a combination of two or more.

From the viewpoint of the smoothness of the resulting coating film, it is preferable to use hydrophobic alcohol solvents as the hydrophobic solvent (E). Among these, C₇₋₁₄ hydrophobic alcoholic solvents are preferable, and it is particularly preferable to use at least one hydrophobic alcohol solvent selected from the group consisting of 1-octanol, 2-octanol, 2-ethyl-1-hexanol, ethylene glycol mono-2-ethylhexyl ether, propylene glycol mono-n-butyl ether, and dipropylene glycol mono-n-butyl ether.

When the aqueous intermediate coating composition (X) contains a hydrophobic solvent (E) as mentioned above, the amount of hydrophobic solvent (E) is preferably 2 to 50 parts by mass, more preferably 5 to 40 parts by mass, and even more preferably 8 to 30 parts by mass, per 100 parts by mass of the total amount of hydroxy- and carboxy-containing polyester resin (A), melamine resin (B), and polycarbodiimide compound (C), on a solids basis.

From the viewpoint of improving the smoothness and distinctness of image, the aqueous intermediate coating composition (X) preferably further contains a diester compound (F).

The diester compound (F) is represented by Formula (I):

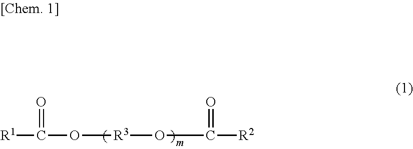

(wherein R¹ and R² are each independently a hydrocarbon group having 4 to 18 carbon atoms, R³ is an alkylene group having 2 to 4 carbon atoms, m is an integer of 3 to 25, and m oxyalkylene units (R³—O) may be the same or different).

From the viewpoint of the smoothness and distinctness of image of the resulting multilayer coating film, the carbon number of each of R¹ and R² in Formula (I) is preferably 4 to 18, more preferably 5 to 11, even more preferably 5 to 9, and still more preferably 6 to 8. R¹ and R² are preferably straight- or branched-chain alkyl groups, and more preferably branched-chain alkyl groups. It is particularly preferable that R¹ and R² be C₆₋₈ branched-chain alkyl groups.

From the viewpoint of the smoothness and distinctness of image of the resulting multilayer coating film, R³ in Formula (1) is preferably a C₂ or C₃ alkylene group, and more preferably a C₂ alkylene group (ethylene group). From the viewpoint of the smoothness and distinctness of image of the resulting multilayer coating film, m in Formula (1) is preferably 4 to 12, and more preferably 6 to 9.

The diester compound (F) preferably has a molecular weight of about 320 to about 1,400, more preferably about 450 to about 1,000, even more preferably about 500 to about 800, and still more preferably about 500 to about 700.

The diester compound (F) is preferably a diester compound of a polyoxyalkylene glycol with an aliphatic monocarboxylic acid. Specifically, the diester compound (F) can be obtained by, for example, an esterification reaction of a polyoxyalkylene glycol having two terminal hydroxy groups with a monocarboxylic acid having a C₄₋₁₈ hydrocarbon group.

Examples of a polyoxyalkylene glycol include polyethylene glycol, polypropylene glycol, copolymers of polyethylene and propylene glycol, polybutylene glycol, etc. Among these, it is particularly preferable to use polyethylene glycol. The polyoxyalkylene glycol preferably has a number average molecular weight of about 100 to about 1,200, more preferably about 150 to about 600, and even more preferably about 200 to about 400.

Examples of a monocarboxylic acid having a C₄₋₁₈ hydrocarbon group include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid, octadecanoic acid, and the like.

Among these, monocarboxylic acids having C₅₋₉ alkyl groups, such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, and 4-ethyloctanoic acid, are preferable; monocarboxylic acids having C₆₋₈ alkyl groups, such as heptanoic acid, 2-ethylpentanoic acid, 3-ethylpentanoic acid, octanoic acid, 2-ethylhexanoic acid, 4-ethylhexanoic acid, nonanoic acid, and 2-ethylheptanoic acid, are more preferable; and monocarboxylic acid having C₆₋₈ branched-chain alkyl groups, such as 2-ethylpentanoic acid, 3-ethylpentanoic acid, 2-ethylhexanoic acid, 4-ethylhexanoic acid, and 2-ethylheptanoic acid, are still more preferable.

These polyoxyalkylene glycols and monocarboxylic acids can be used singly or in a combination of two or more.

The diesterification reaction of the polyoxyalkylene glycol with the monocarboxylic acid having a C₄₋₁₈ hydrocarbon group can be carried out by a known method.

When the aqueous intermediate coating composition (X) contains a diester compound (F) as mentioned above, the amount of diester compound (F) is preferably 1 to 50 parts by mass, more preferably 3 to 25 parts by mass, and still more preferably 5 to 15 parts by mass, per 100 parts by mass of the total amount of hydroxy- and carboxy-containing polyester resin (A), melamine resin (B), and polycarbodiimide compound (C), on a solids basis.

If necessary, the aqueous intermediate coating composition (X) may contain additives for coating compositions, such as thickening agents, UV absorbers, light stabilizers, curing catalysts, antifoaming agents, plasticizers, organic solvents other than the above hydrophobic solvents (E), surface control agents, antisettling agents, etc.

Examples of thickening agents include inorganic thickening agents such as silicate, metal silicate, montmorillonite, colloidal alumina, etc.; polyacrylic acid thickening agents such as copolymers of (meth)acrylic acid and (meth)acrylic ester, sodium polyacrylate, etc.; associative thickening agents having a hydrophilic moiety and a hydrophobic moiety per molecule, and which, in an aqueous medium, effectively improve the viscosity by adsorption of the hydrophobic moiety on the surface of pigments and/or emulsion particles in a coating composition, or by association between hydrophobic moieties; cellulose derivative thickening agents such as carboxymethylcellulose, methylcellulose, hydroxyethylcellulose, etc.; protein thickening agents such as casein, sodium caseinate, ammonium caseinate, etc.; alginate thickening agents such as sodium alginate, etc.; polyvinyl thickening agents such as polyvinyl alcohol, polyvinylpyrrolidone, polyvinyl benzyl ether copolymers, etc.; polyether thickening agents such as pluronic polyether, polyether dialkyl ester, polyether dialkyl ether, polyether epoxy-modified products, etc.; maleic anhydride copolymer thickening agents such as partial esters of a copolymer of vinyl methyl ether and maleic anhydride, etc.; polyamide thickening agents such as polyamide amine salts, etc.; and the like. Such thickening agents can be used singly or in a combination of two or more.

Examples of usable polyacrylic acid thickening agents include commercially available products, which are available, for example, under the trade names “PRIMAL ASE-60”, “PRIMAL TT-615”, and “PRIMAL RM-5”, manufactured by Rohm and Haas; “SN Thickener 613”, “SN Thickener 618”, “SN Thickener 630”, “SN Thickener 634”, and “SN Thickener 636”, manufactured by San Nopco Ltd.; and the like. Examples of usable associative thickening agents include commercially available products, which are available, for example, under the trade names “UH-420”, “UH-450”, “UH-462”, “UH-472”, “UH-540”, “UH-752”, “UH-756VF”, and “UH-814N”, manufactured by ADEKA Co. Ltd.; “PRIMAL RM-8W”, “PRIMAL RM-825”, “PRIMAL RM-2020NPR”, “PRIMAL RM-12W”, and “PRIMAL SCT-275”, manufactured by Rohm and Haas; “SN Thickener 612”, “SN Thickener 621N”, “SN Thickener 625N”, “SN Thickener 627N”, and “SN Thickener 660T”, manufactured by San Nopco Ltd.; and the like.

As a thickening agent, it is preferable to use a polyacrylic acid thickening agent and/or an associative thickening agent, more preferably an associative thickening agent, and still more preferably a urethane associative thickening agent bearing a hydrophobic group at its end(s) and having a urethane bond in a molecular chain. Examples of usable urethane associative thickening agents include commercially available products, which are available, for example, under the trade names “UH-420”, “UH-462”, “UH-472”, “UH-540”, “UH-752”, “UH-756VF”, and “UH-814N”, manufactured by ADEKA Co. Ltd.; “SN thickener 612”, “SN thickener 621N”, “SN thickener 625N”, “SN thickener 627N”, and “SN thickener 660T”, manufactured by San Nopco Ltd.; and the like.

When the aqueous intermediate coating composition (X) comprises a thickening agent as described above, the amount thereof is preferably about 0.01 to about 10 parts by mass, more preferably about 0.02 to about 3 parts by mass, and still more preferably about 0.03 to about 2 parts by mass, per 100 parts by mass of the total solids content of the hydroxy- and carboxy-containing polyester resin (A), melamine resin (B), and polycarbodiimide compound (C).

The aqueous intermediate coating composition (X) can be prepared by mixing and dispersing, in an aqueous medium, a hydroxy- and carboxy-containing polyester resin (A), a melamine resin (B), and a polycarbodiimide compound (C), together with, if necessary, a pigment (D), a hydrophobic solvent (E), and other additives for coating compositions, using a known method. Examples of usable aqueous media include deionized water, and a mixture of deionized water and a hydrophilic organic solvent. Examples of hydrophilic organic solvents include propylene glycol monomethyl ether, etc.

It is usually preferable that the solids content of the aqueous intermediate coating composition (X) be about 30 to about 80 mass %, more preferably about 40 to about 70 mass %, and still more preferably about 45 to about 60 mass %.

The aqueous intermediate coating composition (X) according to the present invention may be a single-component coating composition or a multi-component coating composition; however, a two-component coating composition consisting of a main agent (X1) that contains a hydroxy- and carboxy-containing polyester resin (A) and a melamine resin (B), and a curing agent (X2) that contains a polycarbodiimide compound (C) is preferable in view of storage stability, etc. It is generally desirable that the main agent (X1) further contain a pigment (D) and water, and that the curing agent (X2) further contain water. The curing agent (X2) may further contain a surfactant.

From the viewpoint of the smoothness, distinctness of image, etc., of the resulting coating film, it is preferable that the aqueous intermediate coating composition (X) according to the present invention be applied to a cured film thickness of 30 μm, and have a gel fraction (G₈₀) of generally about 3 to about 100 mass %, preferably about 5 to about 95 mass %, and more preferably about 10 to about 90 mass %, after being heated at 80° C. for 10 minutes.

The gel fraction (G₈₀) can be calculated according to the following method:

First, the aqueous intermediate coating composition (X) is applied to a polypropylene plate to a cured film thickness of 30 μm, and then heated at 80° C. for 10 minutes. The intermediate coating layer over the polypropylene plate is collected to measure the mass (Wₐ). The layer is then placed into a stainless steel container with a 300-mesh sieve, extracted for 5 hours in a solvent mixture containing an equivalent amount of acetone and methanol that has been heated to 64° C., and then dried at 110° C. for 60 minutes. The mass (W_{b}) of the resulting coating layer is then measured. The remaining ratio (mass %) of the insoluble coating layer is calculated according to the following formula and is referred to as a gel fraction (G₈₀).

Gel fraction (G₈₀) (mass %)=(W_{b}/Wₐ)×100

The gel fraction (G₈₀) of the coating composition of the present invention can be controlled, for example, by adjusting the acid value of the hydroxy- and carboxy-containing polyester resin (A), or the proportion of the polycarbodiimide compound (C) in the coating composition.

The aqueous intermediate coating composition (X) can be applied to the substrate using known methods such as air spray coating, airless spray coating, rotary atomization coating, curtain coating, etc. An electrostatic charge may be applied during coating. Among these, air spray coating and rotary atomization coating are preferable.

It is preferable that the aqueous intermediate coating composition (X) be applied in such a manner that the cured film thickness becomes usually about 5 to about 70 μm, preferably about 10 to about 50 μm, and more preferably about 15 to about 40 μm.

### Step (2)

Subsequently, the aqueous base coating composition (Y) is applied to the layer of the aqueous intermediate coating composition (X) (hereinafter sometimes referred to as “intermediate coating film”) formed in Step (1).

It is preferable to perform, prior to the application of the aqueous base coating composition (Y), preheating, air blowing, etc., on the intermediate coating film under conditions in which the coating film does not substantially cure. In the present invention, a cured coating film indicates a film in a dry hard condition according to JIS K 5600-1-1, i.e., a condition in which an imprint due to a fingerprint is not formed on the coating surface and no movement is detected on the coated film when the center of the surface is strongly pinched with a thumb and an index finger, or in which a scrape is unobservable on the coating surface when the center of the surface is rubbed rapidly with a fingertip; the uncured coating film indicates a film that has not yet reached a dry hard condition, including a film in a set-to-touch condition and a film in a dry-to-touch condition according to JIS K 5600-1-1.

The preheating temperature is preferably about 40 to about 120° C., more preferably about 60 to about 100° C., and still more preferably about 70 to about 90° C. The preheating time is preferably about 30 seconds to about 15 minutes, more preferably about 1 to about 12 minutes, and still more preferably about 2 to about 10 minutes. Air blowing can usually be performed by blowing room temperature air or air heated to about 25 to about 80° C. over the coated surface of the substrate for about 30 seconds to about 15 minutes.

It is preferable to adjust the solids content of the intermediate coating film to generally about 60 to about 100 mass %, preferably about 80 to about 100 mass %, and more preferably about 90 to about 100 mass % by means of preheating, air blowing, etc., prior to the application of the aqueous base coating composition (Y). It is further preferable to adjust the gel fraction of the coating film to within the range of generally about 1 to about 95 mass %, preferably about 5 to about 90 mass %, and more preferably about 10 to 85 mass %.

The solids content of the coating film can be calculated according to the following method:

First, an aqueous intermediate coating composition (X) is applied to the substrate. The aqueous intermediate coating composition (X) is also applied to an aluminum foil whose content (W₁) is previously measured. The aluminum foil is subjected to preheating and like treatment after application, and then collected just before the application of the aqueous base coating composition (Y). The content thereof (W₂) is measured. Subsequently, the collected aluminum foil is dried at 110° C. for 60 minutes and allowed to cool to room temperature in a desiccator, thereby obtaining the mass (W₃) of the aluminum foil. The solids content is then measured according to the following formula.

Solids content (mass %)={W₃−W₁)/(W₂−W₁}×100

The gel fraction of the coating film can be calculated according to the following method:

First, an aqueous intermediate coating composition (X) is applied to a substrate. The aqueous intermediate coating composition (X) is also applied to a polypropylene plate, and preheated. The polypropylene plate that is subjected to preheating and like treatment after application is collected just before the application of the aqueous base coating composition (Y). The intermediate coating film on the polypropylene plate is then collected to measure its mass (W_{c}). The film is placed into a stainless steel container with a 300-mesh sieve, extracted for 5 hours in a solvent mixture containing an equivalent amount of acetone and methanol that has been heated to 64° C., and then dried at 110° C. for 60 minutes. The mass (W_{d}) of the resulting coating film is then measured. The remaining ratio (mass %) of the insoluble coating film is calculated according to the following formula, and is referred to as a gel fraction.

Gel fraction (mass %)=(W_{d}/W_{c})×100

The aqueous base coating composition (Y) applied to the intermediate coating film is generally intended to impart an excellent appearance to a substrate. For example, a coating composition obtained by dissolving or dispersing, in water, a resin component comprising a base resin (e.g., acrylic resins, polyester resins, alkyd resins, urethane resins, epoxy resins, etc., all containing crosslinkable functional groups such as carboxy groups, hydroxy groups, etc.) and a curing agent (e.g., blocked or unblocked polyisocyanate compounds, the melamine resin (B), urea resins, etc.), together with pigments and other additives can be used. Among these, a thermosetting aqueous coating composition containing a hydroxy-containing resin as a base resin and the melamine resin (B) as a curing agent can be advantageously used in view of the appearance, water-resistance, etc., of the resulting multilayer coating film.

The coloring pigment (D1), extender pigment (D2), luster pigment (D3), etc., can be used as the above-mentioned pigment. It is particularly preferable that the aqueous base coating composition (Y) contain the coloring pigment (D1) and/or luster pigment (D3) as at least one of the pigments described above.

Examples of the coloring pigment (D1) include titanium oxide, zinc flower, carbon black, molybdenum red, Prussian blue, cobalt blue, azo pigments, phthalocyanine pigments, quinacridone pigments, isoindoline pigments, threne pigments, perylene pigments, dioxazine pigments, diketo-pyrrolo-pyrrole pigments, etc., as mentioned in the description of the aqueous inteimmediate coating composition (X).

When the aqueous base coating composition (Y) includes the coloring pigment (D1), the amount of the coloring pigment (D1) is preferably about 1 to about 150 parts by mass, more preferably about 3 to about 130 parts by mass, and even more preferably about 5 to about 110 parts by mass, per 100 parts by mass of the resin solids content in the aqueous base coating composition (Y).

Examples of the luster pigment (D3) include aluminum (including vapor-deposited aluminum), copper, zinc, brass, nickel, aluminum oxide, mica, titanium oxide-coated or iron oxide-coated aluminum oxide, titanium oxide-coated or iron oxide-coated mica, glassflakes, hologram pigment, etc., as mentioned in the description of the aqueous intermediate coating composition (X). Among these, aluminum, aluminum oxide, mica, titanium oxide- or iron oxide-coated aluminum oxide, and titanium oxide-coated or iron oxide-coated mica are more preferable, and aluminum is even more preferable. Such luster pigments (D3) can be used singly or in a combination of two or more.

The luster pigment (D3) is preferably in the form of flakes. More specifically, the preferable luster pigment (D3) has a longitudinal dimension of about 1 to about 100 μm, and preferably about 5 to about 40 μm, and a thickness of about 0.001 to about 5 μm, and preferably about 0.01 to about 2 μm.

When the aqueous base coating composition (Y) includes the luster pigment (D3), the amount of the luster pigment (D3) is preferably about 1 to about 50 parts by mass, more preferably about 2 to about 30 parts by mass, and even more preferably about 3 to about 20 parts by mass, per 100 parts by mass of the resin solids in the aqueous base coating composition (Y).

It is preferable that the aqueous base coating composition (Y) contain the hydrophobic solvent (E). From the viewpoint of the brilliance of the resulting coating film, it is preferable to use an alcohol hydrophobic solvent as the hydrophobic solvent (E). In particular, C₇₋₁₄ alcohol hydrophobic solvents are preferable. For example, it is particularly preferable to use at least one alcohol hydrophobic solvent selected from the group consisting of 1-octanol, 2-octanol, 2-ethyl-1-hexanol, ethylene glycol mono-2-ethylhexyl ether, propylene glycol mono-n-butyl ether, and dipropylene glycol mono-n-butyl ether.

When the aqueous base coating composition (Y) contains the hydrophobic solvent (E), the amount thereof is preferably about 2 to about 70 parts by mass, more preferably about 11 to about 60 parts by mass, and even more preferably about 16 to about 50 parts by mass, per 100 parts by mass of the resin solids content in the aqueous base coating composition (Y).

The aqueous base coating composition (Y) may further contain, if necessary, conventional additives for coating compositions, such as curing catalysts, thickening agents, UV absorbers, light stabilizers, antifoaming agents, plasticizers, organic solvents, surface control agents, antisettling agents, etc. Such additives can be used singly or in a combination of two or more.

The aqueous base coating composition (Y) can be applied using known methods, such as air spray coating, airless spray coating, rotary atomization coating, etc. An electrostatic charge may be applied during coating. The coating is formed so as to obtain a cured film with a thickness of usually about 5 to about 30 μm, preferably about 8 to about 25 μm, and more preferably about 10 to about 20 μm.

### Step (3)

In the method of forming a multilayer coating film of the present invention, the clear coating composition (Z) is applied to the layer of the aqueous base coating composition (Y) (hereinafter sometimes referred to as “base coating film”) formed in Step (2).

It is preferable to perform, prior to the application of the clear coating composition (Z), preheating, air blowing, etc., on a clear coating layer under conditions in which the coating layer does not substantially cure. The preheating temperature is preferably about 40 to about 100° C., more preferably about 50 to about 90° C., and still more preferably about 60 to about 80° C. The preheating time is preferably about 30 seconds to about 15 minutes, more preferably about 1 to about 10 minutes, and still more preferably about 2 to about 5 minutes. Air blowing can usually be performed by blowing room temperature air or air heated to about 25 to about 80° C. over the coated surface of the substrate for about 30 seconds to 15 minutes.

It is preferable to adjust the solids content of the base coating film to generally about 70 to about 100 mass %, preferably about 80 to about 100 mass %, and more preferably about 90 to about 100 mass % by means of preheating, air blowing, etc., prior to the application of the clear coating composition (Z).

As the clear coating composition (Z), any known thermosetting clear coating compositions for coating an automobile body and the like can be used. Examples thereof include organic-solvent thermosetting coating compositions, aqueous thermosetting coating compositions, and powder thermosetting coating compositions, which comprise a crosslinking agent and a base resin having a crosslinkable functional group.

Examples of crosslinkable functional groups contained in the base resin include carboxy, hydroxy, epoxy, silanol, and the like. Examples of the kinds of base resins include acrylic resins, polyester resins, alkyd resins, urethane resins, epoxy resins, fluororesins, and the like. Examples of crosslinking agents include polyisocyanate compounds, blocked polyisocyanate compounds, melamine resins, urea resins, carboxy-containing compounds, carboxy-containing resins, epoxy-containing resins, epoxy-containing compounds, and the like.

Examples of preferable combinations of base resin/crosslinking agents for the clear coating composition (Z) are carboxy-containing resin/epoxy-containing resin, hydroxy-containing resin/polyisocyanate compound, hydroxy-containing resin/blocked polyisocyanate compound, hydroxy-containing resin/melamine resin, and the like.

The clear coating composition (Z) may be a one-component coating composition, or a multi-component coating composition such as a two-component urethane resin coating composition.

If necessary, the clear coating composition (Z) may contain a coloring pigment (D1), luster pigment (D3), dye, etc., in a degree such that the transparency of the clear coating composition is not impaired, and may also contain an extender pigment (D2), UV absorber, light stabilizer, antifoaming agent, thickening agent, anticorrosive, surface control agent, etc.

The clear coating composition (Z) can be applied to the surface of the aqueous base coating composition (Y) using known methods, such as airless spray coating, air spray coating, rotary atomization coating, etc. An electrostatic charge may be applied during coating. The clear coating composition (Z) is applied to a cured film thickness of generally about 10 to about 80 μm, preferably about 15 to about 60 μm, and more preferably about 20 to about 50 μm.

After application of the clear coating composition (Z), if necessary, it is possible to have an interval of about 1 to about 60 minutes at room temperature, or perform preheating at about 40 to about 80° C. for about 1 to about 60 minutes.

### Step (4)

In the first method of forming a multilayer coating film of the present invention, the uncured intermediate coating layer, uncured base coating layer, and uncured clear coating layer formed in Steps (1) to (3) are simultaneously heat-cured.

The intermediate coating layer, base coating layer, and clear coating layer are cured by a usual baking method, such as hot-air heating, infrared heating, high-frequency heating, and the like. The heating temperature is preferably about 80 to about 180° C., more preferably about 110 to about 170° C., and still more preferably about 130 to about 160° C. The heating time is preferably about 10 to about 90 minutes, and more preferably about 15 to about 60 minutes. This heating allows the multilayer coating film consisting of three layers, i.e., an intermediate coating layer, base coating layer and clear coating layer, to be simultaneously cured.

### EXAMPLES

The present invention is described below in more detail with reference to Examples and Comparative Examples. However, the present invention is not limited to these examples. In the examples, “parts” and “%” are expressed on a weight basis.

### Production of Hydroxy- and Carboxy-Containing Resin (A)

### Production Example 1

Eighty eight grams of adipic acid, 536 g of 1,2-cyclohexanedicarboxylic acid anhydride, 199 g of isophthalic acid, 288 g of 2-butyl-2-ethyl-1,3-propanediol, 95 g of neopentylglycol, 173 g of 1,4-cyclohexane dimethanol, and 287 g of trimethylolpropane were placed into a reaction vessel equipped with a thermometer, a thermostat, a stirrer, a reflux condenser and a water separator, and heated from 160° C. to 230° C. over a period of 3 hours. The reaction was maintained at 230° C. while removing the condensation water using a water separator, and was allowed to proceed until the acid value became 5 mg KOH/g or less. Trimellitic anhydride (86 g) was added to the reaction product, and an additional reaction was performed at 170° C. for 30 minutes. Subsequently, the result was cooled to 50° C. or less, and neutralized by adding 0.9 equivalents of 2-(dimethylamino)ethanol relative to acid groups. Then, deionized water was gradually added to obtain a hydroxy- and carboxy-containing polyester resin aqueous dispersion (A-1) with a solids content of 45% and a pH of 7.2. The resulting hydroxy- and carboxy-containing polyester resin had a hydroxy value of 110 mg KOH/g, an acid value of 33 mg KOH/g, and a number average molecular weight of 2,050.

The acid value measurement was carried out according to JISK-5601-2-1 (1999). More specifically, each sample was dissolved by a mixture solution of toluene/ethanol (2:1 in volume), and the sample was titrated with a potassium hydroxide solution using phenol phthalein as an indicator. Then, the acid value was calculated according to the following equation.

Acid value (mgKOH/g)=56.1×V×C/m

wherein V represents titration amount (ml), C represents concentration (mol/l) of titrate liquid, and m represents solids content by weight (g) of the sample.

The hydroxy value measurement was carried out according to JISK-0070 (1992). More specifically, 5 ml of an acetylating reagent (an anhydrous acetic acid pyridine solution obtained by adding pyridine to 25 g of anhydrous acetic acid, adjusted to its total amount to 100 ml) was added to the sample, and the sample was heated in a glycerin bath. Thereafter, the sample was titrated in a potassium hydroxide solution using phenol phthalein as an indicator. Then, the hydroxy value was calculated according to the following equation.

Hydroxy value (mgKOH/g)=[V×56.1×C/m]+D

wherein V represents titration amount (ml), C represents concentration (mol/l) of titrate liquid, m represents solids content by weight (g) of the sample, and D represents acid value (mgKOH/g) of the sample (hereinafter, a hydroxy value and an acid value are measured using the same method in the specification of the present invention).

The content of the C₄ or higher linear alkylene group in the resulting hydroxy- and carboxy-containing polyester resin is calculated using the following formula.

The molar number of the C₄ or higher linear alkylene group (Wm)

=88/146 (adipic acid)

=0.6 mol

The mass of condensation water

=18×{2×88/146 (adipic acid)+1×536/154 (1,2-cyclohexanedicarboxylic anhydride)+2×199/166 (isophthalic acid)}

=127 g

The resulting amount of the resin without the condensation water (Wr)

=88 (adipic acid)+536 (1,2-cyclohexanedicarboxylic anhydride)+199 (isophthalic acid)+288 (2-butyl-2-ethyl-1,3-propanediole)+95 (neopentyl glycol)+173 (1,4-cyclohexane dimethanol)+287 (trimethylolpropane)+86 (trimellitic anhydride)−127 (condensation water)

=1,624 g

=1.624 kg

The content of the C₄ or higher linear alkylene group

=The number of mol of the C₄ or higher linear alkylene group (Wm)/the resulting amount of the resin without condensation water (Wr)

=0.6/1.624

=0.4 mol/kg (resin solids content)

The total amount of the benzene ring and the cyclohexane ring in the resulting hydroxy- and carboxy-containing polyester resin was calculated according to the following formula.

The total molar number of the benzene ring and the cyclohexane ring (Wn)

=536/154 (1,2-cyclohexanedicarboxylic anhydride)+199/166 (isophtalic acid)+173/144 (1,4-cyclohexane dimethanol)+86/192 (trimellitic anhydride)

=6.33 mol

The total amount of the benzene ring and the cyclohexane ring

=The total molar number of the benzene ring and the cyclohexane ring (Wn)/the resulting amount of the resin without the condensation water (Wr)

=6.33/1.624

=3.9 mol/kg (resin solids content)

### Production Examples 2-18

According to the proportions shown in Table 1 below, hydroxy- and carboxy-containing polyester resin aqueous dispersions (A-2) to (A-18), each having a solids content of 45% and a pH of 7.2 were obtained in the same manner as in Production Example 1. Table 1 shows the hydroxy value, acid value, number average molecular weight, content of the C₄ or higher linear alkylene group, and total amount of the benzene ring and the cyclohexane ring of each of the resulting hydroxy- and carboxy-containing polyester resins, along with the values of the hydroxy- and carboxy-containing polyester resin aqueous dispersion (A-1) obtained in Production Example 1.

TABLE 1

| | | | | Production Example | | | | | | | | |
|---|---|---|---|---|---|---|---|---|---|---|---|---|
| | | | | 1 | 2 | 3 | 4 | 5 | 6 | 7 | 8 | 9 |
| Hydroxy- and carboxy-containing polyester resin | | | | A-1 | A-2 | A-3 | A-4 | A-5 | A-6 | A-7 | A-8 | A-9 |
| aqueous dispersion | | | | | | | | | | | | |
| Acid | Aliphatic | Aliphatic | Adipic acid | 88 | 88 | 88 | 88 | 88 | | 88 | 88 | 88 |
| component | polybasic | dicarboxylic | (Mw: 146) | | | | | | | | | |
| (a-1) | acid | acid | Dodecanedioic acid | | | | | | 276 | | | |
| | (a-1-1) | containing | (Mw: 230) | | | | | | | | | |
| | | C₄ or | | | | | | | | | | |
| | | higher linear | | | | | | | | | | |
| | | alkylene | | | | | | | | | | |
| | | group | | | | | | | | | | |

| | | | | | | | | | | | |
|---|---|---|---|---|---|---|---|---|---|---|---|
| | Alicyclic polybasic acid | 1,2-Cyclohexane | 536 | 480 | 379 | 601 | 351 | 490 | 480 | 480 | 480 |
| | (a-1-2) | dicarboxylic anhydride | | | | | | | | | |
| | | (Mw: 154) | | | | | | | | | |
| | Aromatic polybasic acid | Isophthalic acid | 199 | 199 | 199 | 199 | 199 | 100 | 199 | 199 | 199 |
| | (a-1-3) | (Mw: 166) | | | | | | | | | |
| Alcohol | Aliphatic diol | 2-Butyl-2-ethyl-1,3- | 288 | 336 | 288 | 413 | 288 | 336 | 336 | 336 | 336 |
| component | (a-2-1) | propanediol | | | | | | | | | |
| (a-2) | | (Mw: 160) | | | | | | | | | |
| | | Neopentyl glycol | 95 | 189 | 95 | 95 | 95 | 164 | 189 | 189 | 189 |
| | | (Mw: 105) | | | | | | | | | |
| | Alicyclic diol | 1,4-Cyclohexane | 173 | | 173 | 173 | 173 | | | | |
| | (a-2-2) | dimethanol | | | | | | | | | |
| | | (Mw: 144) | | | | | | | | | |
| | | Trimethylolpropane | 287 | 287 | 287 | 180 | 287 | 319 | 287 | 287 | 287 |
| | | (Mw: 134) | | | | | | | | | |
| Acid | Aromatic polybasic acid | Trimellitic anhydride | 86 | 86 | 86 | 86 | 86 | 17 | 29 | 144 | 196 |
| component | (a-1-3) | (Mw: 192) | | | | | | | | | |
| (a-1) | | | | | | | | | | | |

| Hydroxy value [mgKOH/g] | | | | 110 | 140 | 195 | 50 | 213 | 157 | 155 | 120 | 110 |
|---|---|---|---|---|---|---|---|---|---|---|---|---|
| Acid value [mgKOH/g] | | | | 33 | 35 | 36 | 31 | 36 | 8 | 13 | 55 | 65 |
| Number average Mw | | | | 2050 | 1360 | 830 | 4710 | 750 | 1330 | 1340 | 1450 | 1480 |
| Content of C₄ or higher linear alkylene group | | | | 0.4 | 0.4 | 0.4 | 0.4 | 0.4 | 0.8 | 0.4 | 0.4 | 04 |
| [mol/kg (resin solids content)] | | | | | | | | | | | | |
| Total amount of benzene ring and cyclohexane ring | | | | 3.9 | 3.1 | 3.6 | 4.0 | 3.5 | 2.4 | 3.0 | 3.2 | 3.2 |
| [mol/kg (resin solids content)] | | | | | | | | | | | | |
| | | | | Production Example | | | | | | | | |
| | | | | 10 | 11 | 12 | 13 | 14 | 15 | 16 | 17 | 18 |
| Hydroxy- and carboxy-containing polyester resin | | | | A-10 | A-11 | A-12 | A-13 | A-14 | A-15 | A-16 | A-17 | A-18 |
| aqueous dispersion | | | | | | | | | | | | |
| Acid | Aliphatic | Aliphatic | Adipic acid | 88 | 88 | 88 | 88 | 44 | 438 | 464 | 394 | 88 |
| component | polybasic | dicarboxylic | (Mw: 146) | | | | | | | | | |
| (a-1) | acid | acid containing | Dodecanedioic acid | | | | | | | | | |
| | (a-1-1) | C₄ or | (Mw: 230) | | | | | | | | | |
| | | higher linear | | | | | | | | | | |
| | | alkylene group | | | | | | | | | | |
| | Alicyclic polybasic acid | | 1,2-Cyclohexane | 314 | 554 | 601 | 610 | 370 | 305 | 277 | 259 | 397 |
| | (a-1-2) | | dicarboxylic | | | | | | | | | |
| | | | anhydride | | | | | | | | | |
| | | | (Mw: 154) | | | | | | | | | |
| | Aromatic polybasic acid | | Isophthalic acid | 199 | 199 | 199 | 199 | 378 | | | 100 | 299 |
| | (a-1-3) | | (Mw: 166) | | | | | | | | | |
| Alcohol | Aliphatic | Aliphatic diol | 1,6-Hexanediol | | | | | | 142 | | | |
| component | diol | containing C₄ | (Mw: 118) | | | | | | | | | |
| (a-2) | (a-2-1) | or higher linear | | | | | | | | | | |
| | | alkylene group | | | | | | | | | | |
| | | | 2-Butyl-2-ethyl-1,3- | 432 | 288 | 288 | 288 | 336 | 134 | 336 | 355 | 288 |
| | | | propanediol | | | | | | | | | |
| | | | (Mw: 160) | | | | | | | | | |
| | | | Neopentyl glycol | 95 | 95 | 95 | 95 | 183 | | 202 | 189 | |
| | | | (Mw: 105) | | | | | | | | | |

| | | | | | | | | | | | |
|---|---|---|---|---|---|---|---|---|---|---|---|
| | Alicyclic diol | 1,4-Cyclohexane | 173 | 173 | 173 | 173 | | 259 | | | 285 |
| | (a-2-2) | dimethanol | | | | | | | | | |
| | | (Mw: 144) | | | | | | | | | |
| | | Trimethylolpropane | 164 | 287 | 287 | 287 | 295 | 295 | 270 | 270 | 303 |
| | | (Mw: 134) | | | | | | | | | |
| Acid | Aromatic polybasic acid | Trimellitic | 86 | 86 | 86 | 86 | 52 | 52 | 50 | 48 | 50 |
| component | (a-1-3) | anhydride | | | | | | | | | |
| (a-1) | | (Mw: 192) | | | | | | | | | |

| | | | | | | | | | |
|---|---|---|---|---|---|---|---|---|---|
| Hydroxy value [mgKOH/g] | 198 | 100 | 77 | 73 | 147 | 151 | 147 | 150 | 145 |
| Acid value [mgKOH/g] | 36 | 32 | 31 | 31 | 20 | 20 | 20 | 25 | 20 |
| Number average Mw | 650 | 2430 | 4650 | 5630 | 1420 | 1380 | 1355 | 1360 | 1465 |
| Content of C₄ or higher linear alkylene group | 0.4 | 0.4 | 0.4 | 0.4 | 0.2 | 2.8 | 2.2 | 1.8 | 0.4 |
| [mol/kg (resin solids content)] | | | | | | | | | |
| Total amount of benzene ring and cyclohexane ring | 3.4 | 3.9 | 4.0 | 4.0 | 3.3 | 2.7 | 1.4 | 1.7 | 4.2 |
| [mol/kg (resin solids content)] | | | | | | | | | |

### Production of Hydroxy-Containing Acrylic Resin

### Production Example 19

A 30 part quantity of propylene glycol monopropyl ether was placed into a reaction vessel equipped with a thermometer, a thermostat, a stirrer, a reflux condenser, a nitrogen inlet tube and a dropping funnel, and heated to 85° C. A mixture of 10 parts of styrene, 30 parts of methyl methacrylate, 15 parts of 2-ethylhexyl acrylate, 11.5 parts of n-butyl acrylate, 30 parts of hydroxyethyl acrylate, 3.5 parts of acrylic acid, 10 parts of propylene glycol monopropyl ether and 2 parts of 2,2′-azobis(2,4-dimethylvaleronitrile) was added dropwise into a flask over a period of 4 hours, and then aged for 1 hour. A mixture of 5 parts of propylene glycol monopropyl ether and 1 part of 2,2′-azobis(2,4-dimethylvaleronitrile) was further added dropwise into a flask for 1 hour, and after completion of the dropwise addition, aging was conducted for 1 hour. Subsequently, 3.03 parts of 2-(dimethylamino)ethanol was added to the reaction product. Deionized water was gradually added to thereby obtain a hydroxy-containing acrylic resin dispersion (AC-1) with a solids content of 40%. The resulting hydroxy-containing acrylic resin had an acid value of 27 mg KOH/g and a hydroxy value of 145 mg KOH/g.

### Production Example 20

A 70.7 part quantity of deionized water and 0.52 parts of polyoxyethylene alkyl ether sulfate ester ammonium salt (trade name “Aqualon KH-10”, produced by Dai-Ichi Kogyo Seiyaku Co., Ltd., active ingredient: 97%) were placed into a reaction vessel equipped with a thermometer, a thermostat, a stirrer, a reflux condenser, a nitrogen inlet tube and a dropping funnel. The mixture was stirred and mixed in a nitrogen flow, and heated to 80° C. Subsequently, 1% of the total amount of the emulsified monomer (1) described below and 5 parts of 6% ammonium persulfate solution were introduced into a reaction vessel, and maintained at 80° C. for 15 minutes. The remaining emulsified monomer (1) was added dropwise into a reaction vessel over a period of 3 hours while the same temperature was maintained. After completion of the dropwise addition, the reaction product was aged for 1 hour. Gradually adding 40 parts of 5% 2-(dimethylamino)ethanol solution into a reaction vessel, the reaction product was cooled to 30° C., and filtrated using 100-mesh nylon cloth to obtain a filtrate of a hydroxy-containing acrylic resin dispersion (AC-2) with a solids content of 45%. The resulting hydroxy-containing acrylic resin had an acid value of 12 mg KOH/g and a hydroxy value of 43 mg KOH/g.

Emulsified monomer (1): 50 parts of deionized water, 10 parts of styrene, 40 parts of methyl methacrylate, 35 parts of ethylacrylate, 3.5 parts of n-butyl methacrylate, 10 parts of 2-hydroxyethyl methacrylate, 1.5 parts of acrylic acid, 1 part of “Aqualon KH-10” and 0.03 parts of ammonium persulfate were mixed while stirring to obtain emulsified monomer (1).

### Production Example 21

A 50 part quantity of deionized water and 0.2 parts of an emulsifier (trade name “Adekaria Soap SR-1025”, produced by ADEKA Co., Ltd., active ingredient: 25%) were placed into a reaction vessel equipped with a thermometer, a thermostat, a stirrer, a reflux condenser, a nitrogen inlet tube and a dropping funnel. The mixture was stirred and mixed in a nitrogen flow, and heated to 80° C. Subsequently, 3% of the total amount of the emulsified monomer described below and 1 part of 5% ammonium persulfate solution were introduced into a reaction vessel, and maintained at 80° C. for 20 minutes. The remaining emulsified monomer was added dropwise into a reaction vessel over a period of 3 hours while the same temperature was maintained. After completion of the dropwise addition, the reaction product was aged for 90 minutes, and then cooled. When the temperature of the reaction product became 40° C. or less, 10 parts of 5% 2-(dimethylamino)ethanol solution was gradually added to the reaction vessel, followed by stirring for 10 minutes while cooling. Thereafter, the reaction product was filtrated using 100-mesh nylon cloth to obtain a filtrate of a water-dispersible hydroxy- and carboxy-containing acrylic resin aqueous dispersion (G-1) having a mean particle diameter of 150 nm and a solids content of 45%. The resulting water-dispersible hydroxy- and carboxy-containing acrylic resin had a hydroxy value of 41 mg KOH/g and an acid value of 36 mg KOH/g.

Emulsified monomer: 55 parts of deionized water, 8 parts of “Adekaria Soap SR-1025”, 0.2 parts of ammonium persulfate, 40 parts of n-butyl acrylate, 35 parts of 2-ethylhexyl acrylate, 9.5 parts of 2-hydroxyethyl acrylate, 5.5 parts of methacrylic acid and 10 parts of styrene were mixed while stirring to obtain an emulsified monomer.

### Production Examples 22-27

According to the proportions shown in Table 2 below, water-dispersible hydroxy- and carboxy-containing acrylic resin aqueous dispersions (G-2) to (G-7) each having a solids content of 45% were obtained in the same manner as in Production Example 21. Table 2 shows the hydroxy value, acid value, and proportions of C₄₋₂₄ alkyl group-containing polymerizable unsaturated monomer (g-1), hydroxy-containing polymerizable unsaturated monomer (g-2) and carboxy-containing polymerizable unsaturated monomer (g-3) based on the total mass of monomer component (g) of each of the resulting water-dispersible hydroxy- and carboxy-containing acrylic resin aqueous dispersions along with the values of the water-dispersible hydroxy- and carboxy-containing acrylic resin aqueous dispersion (G-1) obtained in Production Example 20.

TABLE 2

| | | | | Production Example | | | | | | |
|---|---|---|---|---|---|---|---|---|---|---|
| | | | | 21 | 22 | 23 | 24 | 25 | 26 | 27 |
| Water-dispersible hydroxy- and carboxy-containing | | | | G-1 | G-2 | G-3 | G-4 | G-5 | G-6 | G-7 |
| acrylic resin aqueous dispersion | | | | | | | | | | |
| Deionized water | | | | 50 | 50 | 50 | 50 | 50 | 50 | 50 |
| Adekaria Soap SR-1025 | | | | 0.2 | 0.2 | 0.2 | 0.2 | 0.2 | 0.2 | 0.2 |
| 5% Ammonium persulfate solution | | | | 1 | 1 | 1 | 1 | 1 | 1 | 1 |
| Emulsified | Deionized water | | | 55 | 55 | 55 | 55 | 55 | 55 | 55 |
| monomer | Adekaria Soap SR-1025 | | | 8 | 8 | 8 | 8 | 8 | 8 | 8 |
| | Ammonium persulfate | | | 0.2 | 0.2 | 0.2 | 0.2 | 0.2 | 0.2 | 0.2 |
| | Monomer | Polymerizable | n-Butyl acrylate | 40 | 20 | | 50 | 35.5 | 50 | 39.5 |
| | component (g) | unsaturated | 2-Ethylhexylacrylate | 35 | 20 | | 30 | 25 | 34 | 25 |
| | | monomer | | | | | | | | |
| | | containing C₄ or | | | | | | | | |
| | | higer alkyl group | | | | | | | | |
| | | (g-1) | | | | | | | | |
| | | Hydroxy- | 2-Hydroxyethyl | 9.5 | 9.5 | 9.5 | 9.5 | 9.5 | 0.5 | 20 |
| | | containing | (meth) acrylate | | | | | | | |
| | | polymerizable | | | | | | | | |
| | | unsaturated | | | | | | | | |
| | | monomer (g-2) | | | | | | | | |
| | | Carboxy- | Methacrylic acid | 5.5 | 5.5 | 5.5 | 0.5 | 20 | 5.5 | 5.5 |
| | | containing | | | | | | | | |
| | | polymerizable | | | | | | | | |
| | | unsaturated | | | | | | | | |
| | | monomer (g-3) | | | | | | | | |
| | | Other | Methyl methacrylate | | 20 | 50 | | | | |
| | | polymerizable | Ethyl acrylate | | 25 | 35 | | | | |
| | | unsaturated | Styrene | 10 | | | 10 | 10 | 10 | 10 |
| | | monomers | | | | | | | | |
| | | (g-4) | | | | | | | | |

| | | | | | | | |
|---|---|---|---|---|---|---|---|
| 5% 2-(Dimethylamino)ethanol solution | 10 | 10 | 10 | 10 | 10 | 10 | 10 |
| Solids content [%] | 45 | 45 | 45 | 45 | 45 | 45 | 45 |
| Hydroxy value [mgKOH/g] | 41 | 41 | 41 | 41 | 41 | 2 | 86 |
| Acid value [mgKOH/g] | 36 | 36 | 36 | 3 | 130 | 36 | 36 |
| Content of C₄₋₂₄ alkyl group-containing | 75 | 40 | 0 | 80 | 61 | 84 | 65 |
| polymerizable unsaturated monomer (g-1) [%] | | | | | | | |
| Content of hydroxy-containing polymerizable | 9.5 | 9.5 | 9.5 | 9.5 | 9.5 | 0.5 | 20 |
| unsaturated monomer | | | | | | | |
| (g-2) [%] | | | | | | | |
| Content of carboxy-containing polymerizable | 5.5 | 5.5 | 5.5 | 0.5 | 20 | 5.5 | 5.5 |
| unsaturated monomer | | | | | | | |
| (g-3) [%] | | | | | | | |

### Production of Aqueous Intermediate Coating Composition (X)

### Production Example 28

A 44 part quantity (resin solids content: 20 parts) of hydroxy- and carboxy-containing polyester resin aqueous dispersion (A-1) obtained in Production Example 1, 60 parts of rutile titanium dioxide (D1-1) (trade name “JR-806”, produced by TAYCA CORP.), 1 part of carbon black (D1-2) (trade name “Carbon MA-100”, produced by Mitsubishi Chemical, Inc.), 15 parts of barium sulfate powder (D2-1) (trade name “Bariace B-35”, produced by Sakai Chemical Industry Co., Ltd.) having an average primary particle diameter of 0.5 μm, 3 parts of powdered talc (D2-2) (trade name “MICRO ACE S-3”, produced by Nippon Talc Co., Ltd.) having an average primary particle diameter of 4.8 μm, and 11 parts of deionized water were mixed. After being adjusted to a pH of 8.0 with 2-(dimethylamino)ethanol, the mixture was dispersed using a paint shaker for 30 minutes to obtain a pigment dispersion paste.

Next, 134 parts of the resulting pigment dispersion paste, 100 parts of hydroxy- and carboxy-containing polyester resin aqueous dispersion (A-1) obtained in Production Example 1, parts of melamine resin (B-1) (a methyl-butyl-etherified melamine resin, molar ratio of methoxy/butoxy=70/30, weight average molecular weight: 800, solids content: 80%), 38 parts of polycarbodiimide compound (C-1) (trade name “Carbodilite SV-02” produced by Nisshinbo Industries, Inc., solids content 40%), and 10 parts of hydrophobic solvent (E-1) (2-ethyl-1-hexanol (mass dissolved in 100 g of water at 20° C.: 0.1 g)) were homogeneously mixed.

Subsequently, a urethane associative thickening agent (trade name “UH-752”, produced by ADEKA Co., Ltd.), 2-(dimethylamino)ethanol, and deionized water were added to the resulting mixture, to obtain an aqueous intermediate coating composition (X-1) having a pH of 8.0, a solids content of 48%, and a viscosity of 40 seconds as measured at 20° C. using Ford Cup No. 4. The application was conducted so that the resulting aqueous intermediate coating composition (X-1) had a cured film thickness of 30 μm, and the gel fraction (G₈₀) of the coating film after being heated at 80° C. for 10 minutes was 31%.

### Production Examples 29-68

According to the proportions shown in Table 3 below, aqueous intermediate coating compositions (X-2) to (X-41) each having a pH of 8.0, solids content of 48%, and a viscosity of 40 seconds as measured at 20° C. using Ford Cup No. 4 were obtained in the same manner as in Production Example 1.

In Production Example 46, 10 parts of the diester compound (F-1) described below was further added in the production of aqueous intermediate coating composition (X). In Production Example 47, 10 parts of ethylene glycol mono-n-butyl ether (mass dissolved in 100 g of water at 20° C.: unlimited) was added in place of the hydrophobic solvent (E-1). In Production Example 48, 10 parts of the diester compound (F-2) described below was further added in the production of aqueous intermediate coating composition (X). In Production Example 49, 26 parts of a blocked polyisocyanate compound (trade name “Bayhydrol VPLS2310”, produced by Sumika Bayer Urethane Co., Ltd., solids content: 38%) was added during the production of the aqueous intermediate coating composition (X). In Production Example 50, urethane emulsion (trade name “U Coat UX-8100”, produced by Sanyo Chemical Industries, Ltd., a solids content of 35%) was added during the production of the aqueous intermediate coating composition (X).

Melamine resins (B-2 to B-8) represented in Table 3 are as follows.

Melamine resin (B-2): a methyl-butyl-etherified melamine resin, molar ratio of methoxy/butoxy=10/90, weight average molecular weight: 3,800, solids content: 60%

Melamine resin (B-3): a methyl-butyl-etherified melamine resin, molar ratio of methoxy/butoxy=30/70, weight average molecular weight: 550, solids content: 80%

Melamine resin (B-4): a methyl-etherified melamine resin, molar ratio of methoxy/butoxy=100/0, weight average molecular weight: 450, solids content: 80%

Melamine resin (B-5): a methyl-butyl-etherified melamine resin, molar ratio of methoxy/butoxy=80/20, weight average molecular weight: 650, solids content: 80%

Melamine resin (B-6): a butyl-etherified melamine resin, molar ratio of methoxy/butoxy=0/100, weight average molecular weight: 4,300, solids content: 60%

Melamine resin (B-7): a methyl-butyl-etherified melamine resin, molar ratio of methoxy/butoxy=50/50, weight average molecular weight: 1,200, solids content: 80%

Melamine resin (B-8): a methyl-butyl-etherified melamine resin, molar ratio of methoxy/butoxy=90/10, weight average molecular weight: 2,500, solids content: 80%

Polycarbodiimide compound (C-2) represented in Table 3 is as follows.

Polycarbodiimide Compound (C-2): “Carbodilite V-02”, produced by Nisshinbo Industries, Inc., solids content: 40%

Diester compounds (F-1) and (F-2) represented in Table 3 are as follows.

Diester compound (F-1): a diester compound of polyoxypropylene glycol and n-octanoic acid, the diester compound being represented by Formula (I), wherein R¹ and R² are heptyl, R³ is propylene, and m is 7. This diester compound has a molecular weight of 676.

Diester compound (F-2): a diester compound of polyoxyethylene glycol and 2-ethylhexanoic acid, the diester compound being represented by Formula (I), wherein R¹ and R² are 2-ethylpentyl, R³ is ethylene, and m is 7. This diester compound has a molecular weight of 578.

TABLE 3

| | | | | Production Example | | | | | | | | | |
|---|---|---|---|---|---|---|---|---|---|---|---|---|---|
| | | | | 28 | 29 | 30 | 31 | 32 | 33 | 34 | 35 | 36 | 37 |
| Aqueous intermediate coating composition (X) | | | | X-1 | X-2 | X-3 | X-4 | X-5 | X-6 | X-7 | X-8 | X-9 | X-10 |
| Pigment | Hydroxy- and carboxy- | | Type | A-1 | A-2 | A-3 | A-7 | A-8 | A-11 | A-12 | A-14 | A-15 | A-16 |
| dispersion paste | containing | | Amount | 44 | 44 | 44 | 44 | 44 | 44 | 44 | 44 | 44 | 44 |
| | polyester resin (A) | | | | | | | | | | | | |
| | Pigment (D) | Coloring pigment | Type | D1-1 | D1-1 | D1-1 | D1-1 | D1-1 | D1-1 | D1-1 | D1-1 | D1-1 | D1-1 |
| | | (D1) | Amount | 60 | 60 | 60 | 60 | 60 | 60 | 60 | 60 | 60 | 60 |
| | | | Type | D1-2 | D1-2 | D1-2 | D1-2 | D1-2 | D1-2 | D1-2 | D1-2 | D1-2 | D1-2 |
| | | | Amount | 1 | 1 | 1 | 1 | 1 | 1 | 1 | 1 | 1 | 1 |
| | | Extender pigment | Type | D2-1 | D2-1 | D2-1 | D2-1 | D2-1 | D2-1 | D2-1 | D2-1 | D2-1 | D2-1 |
| | | (D2) | Amount | 15 | 15 | 15 | 15 | 15 | 15 | 15 | 15 | 15 | 15 |
| | | | Type | D2-2 | D2-2 | D2-2 | D2-2 | D2-2 | D2-2 | D2-2 | D2-2 | D2-2 | D2-2 |
| | | | Amount | 3 | 3 | 3 | 3 | 3 | 3 | 3 | 3 | 3 | 3 |
| Hydroxy- and carboxy-containing polyester | | | Type | A-1 | A-2 | A-3 | A-7 | A-8 | A-11 | A-12 | A-14 | A-15 | A-16 |
| resin (A) | | | Amount | 100 | 100 | 100 | 100 | 100 | 100 | 100 | 100 | 100 | 100 |
| Melamine resin (B) | | | Type | B-1 | B-1 | B-1 | B-1 | B-1 | B-1 | B-1 | B-1 | B-1 | B-1 |
| | | | Amount | 25 | 25 | 25 | 25 | 25 | 25 | 25 | 25 | 25 | 25 |
| Polycarbodiimide compound (C) | | | Type | C-1 | C-1 | C-1 | C-1 | C-1 | C-1 | C-1 | C-1 | C-1 | C-1 |
| | | | Amount | 38 | 38 | 38 | 38 | 38 | 38 | 38 | 38 | 38 | 38 |
| Hydrophobic solvent (E) | | | Type | E-1 | E-1 | E-1 | E-1 | E-1 | E-1 | E-1 | E-1 | E-1 | E-1 |
| | | | Amount | 10 | 10 | 10 | 10 | 10 | 10 | 10 | 10 | 10 | 10 |
| Gel fraction (G₈₀) of the coating film after being | | | | 31 | 34 | 33 | 32 | 30 | 34 | 33 | 30 | 31 | 33 |
| heated at 80° C. for 10 minutes [%] | | | | | | | | | | | | | |
| | | | | Production Example | | | | | | | | | |
| | | | | 38 | 39 | 40 | 41 | 42 | 43 | 44 | 45 | 46 | 47 |
| Aqueous intermediate coating composition (X) | | | | X-11 | X-12 | X-13 | X-14 | X-15 | X-16 | X-17 | X-18 | X-19 | X-20 |
| Pigment | Hydroxy- and | | Type | A-17 | A-18 | A-2 | A-2 | A-2 | A-2 | A-2 | A-2 | A-2 | A-2 |
| dispersion paste | carboxy-containing | | Amount | 44 | 44 | 44 | 44 | 44 | 44 | 44 | 44 | 44 | 44 |
| | polyester resin (A) | | | | | | | | | | | | |
| | Pigment (D) | Coloring pigment | Type | D1-1 | D1-1 | D1-1 | D1-1 | D1-1 | D1-1 | D1-1 | D1-1 | D1-1 | D1-1 |
| | | (D1) | Amount | 60 | 60 | 60 | 60 | 60 | 60 | 60 | 60 | 60 | 60 |
| | | | Type | D1-2 | D1-2 | D1-2 | D1-2 | D1-2 | D1-2 | D1-2 | D1-2 | D1-2 | D1-2 |
| | | | Amount | 1 | 1 | 1 | 1 | 1 | 1 | 1 | 1 | 1 | 1 |
| | | Extender pigment | Type | D2-1 | D2-1 | D2-1 | D2-1 | D2-1 | D2-1 | D2-1 | D2-1 | D2-1 | D2-1 |
| | | (D2) | Amount | 15 | 15 | 15 | 15 | 15 | 15 | 15 | 15 | 15 | 15 |
| | | | Type | D2-2 | D2-2 | D2-2 | D2-2 | D2-2 | D2-2 | D2-2 | D2-2 | D2-2 | D2-2 |
| | | | Amount | 3 | 3 | 3 | 3 | 3 | 3 | 3 | 3 | 3 | 3 |
| Hydroxy- and carboxy-containing polyester resin | | | Type | A-17 | A-18 | A-2 | A-2 | A-2 | A-2 | A-2 | A-2 | A-2 | A-2 |
| (A) | | | Amount | 100 | 100 | 56 | 100 | 100 | 100 | 100 | 100 | 100 | 100 |
| Hydroxy-containing acrylic resin | | | Type | | | AC-1 | | | | | | | |
| | | | Amount | | | 25 | | | | | | | |
| | | | Type | | | AC-2 | | | | | | | |
| | | | Amount | | | 22 | | | | | | | |
| Melamine resin (B) | | | Type | B-1 | B-1 | B-1 | B-2 | B-3 | B-5 | B-7 | B-8 | B-1 | B-1 |
| | | | Amount | 25 | 25 | 25 | 33 | 25 | 25 | 25 | 29 | 25 | 25 |
| Polycarbodiimide compound (C) | | | Type | C-1 | C-1 | C-1 | C-1 | C-1 | C-1 | C-1 | C-1 | C-2 | C-1 |
| | | | Amount | 38 | 38 | 38 | 38 | 38 | 38 | 38 | 38 | 38 | 38 |
| Hydrophobic solvent (E) | | | Type | E-1 | E-1 | E-1 | E-1 | E-1 | E-1 | E-1 | E-1 | E-1 | |
| | | | Amount | 10 | 10 | 10 | 10 | 10 | 10 | 10 | 10 | 10 | |
| Diester compound (F) | | | Type | | | | | | | | | F-1 | |
| | | | Amount | | | | | | | | | 10 | |
| Ethylene glycol mono-n-butyl ether | | | Amount | | | | | | | | | | 10 |
| Gel fraction (G₈₀) of the coating film after | | | | 32 | 30 | 32 | 31 | 30 | 34 | 33 | 33 | 34 | 32 |
| being heated at 80° C. for 10 minutes [%] | | | | | | | | | | | | | |
| | | | | Production Example | | | | | | | | | |
| | | | | 48 | 49 | 50 | 51 | 52 | 53 | 54 | 55 | 56 | 57 |
| Aqueous intermediate coating composition (X) | | | | X-21 | X-22 | X-23 | X-24 | X-25 | X-26 | X-27 | X-28 | X-29 | X-30 |
| Pigment | Hydroxy- and | | Type | A-2 | A-2 | A-2 | A-2 | A-2 | A-2 | A-2 | A-2 | A-2 | A-2 |
| dispersion paste | carboxy-containing | | Amount | 44 | 44 | 44 | 44 | 44 | 44 | 44 | 44 | 44 | 44 |
| | polyester resin (A) | | | | | | | | | | | | |
| | Pigment (D) | Coloring pigment | Type | D1-1 | D1-1 | D1-1 | D1-1 | D1-1 | D1-1 | D1-1 | D1-1 | D1-1 | D1-1 |
| | | (D1) | Amount | 60 | 60 | 60 | 60 | 60 | 60 | 60 | 60 | 60 | 60 |
| | | | Type | D1-2 | D1-2 | D1-2 | D1-2 | D1-2 | D1-2 | D1-2 | D1-2 | D1-2 | D1-2 |
| | | | Amount | 1 | 1 | 1 | 1 | 1 | 1 | 1 | 1 | 1 | 1 |
| | | Extender pigment | Type | D2-1 | D2-1 | D2-1 | D2-1 | D2-1 | D2-1 | D2-1 | D2-1 | D2-1 | D2-1 |
| | | (D2) | Amount | 15 | 15 | 15 | 15 | 15 | 15 | 15 | 15 | 15 | 15 |
| | | | Type | D2-2 | D2-2 | D2-2 | D2-2 | D2-2 | D2-2 | D2-2 | D2-2 | D2-2 | D2-2 |
| | | | Amount | 3 | 3 | 3 | 3 | 3 | 3 | 3 | 3 | 3 | 3 |

| | | | | | | | | | | | |
|---|---|---|---|---|---|---|---|---|---|---|---|
| Hydroxy- and carboxy-containing polyester | Type | A-2 | A-2 | A-2 | A-2 | A-2 | A-2 | A-2 | A-2 | A-2 | A-2 |
| resin (A) | Amount | 100 | 100 | 89 | 56 | 56 | 56 | 56 | 56 | 56 | 56 |
| Hydroxy-containing acrylic resin | Type | | | | G-1 | G-2 | G-3 | G-4 | G-5 | G-6 | G-7 |
| | Amount | | | | 44 | 44 | 44 | 44 | 44 | 44 | 44 |
| Melamine resin (B) | Type | B-1 | B-7 | B-7 | B-1 | B-1 | B-1 | B-1 | B-1 | B-1 | B-1 |
| | Amount | 25 | 13 | 19 | 25 | 25 | 25 | 25 | 25 | 25 | 25 |
| Polycarbodiimide compound (C) | Type | C-1 | C-1 | C-1 | C-1 | C-1 | C-1 | C-1 | C-1 | C-1 | C-1 |
| | Amount | 38 | 38 | 38 | 38 | 38 | 38 | 38 | 38 | 38 | 38 |
| Hydrophobic solvent (E) | Type | E-1 | E-1 | E-1 | E-1 | E-1 | E-1 | E-1 | E-1 | E-1 | E-1 |
| | Amount | 10 | 10 | 10 | 10 | 10 | 10 | 10 | 10 | 10 | 10 |
| Diester compound (F) | Type | F-2 | | | | | | | | | |
| | Amount | 10 | | | | | | | | | |
| U Coat UX-8100 | Amount | | | 29 | | | | | | | |
| Bayhydrol VPLS2310 | Amount | | 26 | | | | | | | | |

| Gel fraction (G₈₀) of the coating film after | | | | | 31 | 33 | 31 | 32 | 32 | 32 | 31 | 34 | 32 | 33 |
|---|---|---|---|---|---|---|---|---|---|---|---|---|---|---|
| being heated at 80° C. for 10 minutes [%] | | | | | | | | | | | | | | |
| | | | | Production Example | | | | | | | | | | |
| | | | | 58 | 59 | 60 | 61 | 62 | 63 | 64 | 65 | 66 | 67 | 68 |
| Aqueous intermediate coating composition (X) | | | | X-31 | X-32 | X-33 | X-34 | X-35 | X-36 | X-37 | X-38 | X-39 | X-40 | X-41 |
| Pigment | Hydroxy- and carboxy- | | Type | | A-2 | A-2 | A-4 | A-5 | A-6 | A-9 | A-10 | A-13 | A-2 | A-2 |
| dispersion | containing | | Amount | | 44 | 44 | 44 | 44 | 44 | 44 | 44 | 44 | 44 | 44 |
| | polyester resin (A) | | | | | | | | | | | | | |
| paste | Hydroxy-containing acrylic | | Type | AC-1 | | | | | | | | | | |
| | resin | | Amount | 50 | | | | | | | | | | |
| | Pigment (D) | Coloring pigment | Type | D1-1 | D1-1 | D1-1 | D1-1 | D1-1 | D1-1 | D1-1 | D1-1 | D1-1 | D1-1 | D1-1 |
| | | (D1) | Amount | 60 | 60 | 60 | 60 | 60 | 60 | 60 | 60 | 60 | 60 | 60 |
| | | | Type | D1-2 | D1-2 | D1-2 | D1-2 | D1-2 | D1-2 | D1-2 | D1-2 | D1-2 | D1-2 | D1-2 |
| | | | Amount | 1 | 1 | 1 | 1 | 1 | 1 | 1 | 1 | 1 | 1 | 1 |
| | | Extender pigment | Type | D2-1 | D2-1 | D2-1 | D2-1 | D2-1 | D2-1 | D2-1 | D2-1 | D2-1 | D2-1 | D2-1 |
| | | (D2) | Amount | 15 | 15 | 15 | 15 | 15 | 15 | 15 | 15 | 15 | 15 | 15 |
| | | | Type | D2-2 | D2-2 | D2-2 | D2-2 | D2-2 | D2-2 | D2-2 | D2-2 | D2-2 | D2-2 | D2-2 |
| | | | Amount | 3 | 3 | 3 | 3 | 3 | 3 | 3 | 3 | 3 | 3 | 3 |

| | | | | | | | | | | | | |
|---|---|---|---|---|---|---|---|---|---|---|---|---|
| Hydroxy- and carboxy-containing | Type | | A-9 | A-2 | A-4 | A-5 | A-6 | A-9 | A-10 | A-13 | A-2 | A-2 |
| polyester resin (A) | Amount | | 111 | 111 | 100 | 100 | 100 | 100 | 100 | 100 | 100 | 100 |
| Hydroxy-containing acrylic resin | Type | AC-2 | | | | | | | | | | |
| | Amount | 100 | | | | | | | | | | |
| Melamine resin (B) | Type | B-1 | | B-1 | B-1 | B-1 | B-1 | B-1 | B-1 | B-1 | B-6 | B-4 |
| | Amount | 25 | | 38 | 25 | 25 | 25 | 25 | 25 | 25 | 33 | 25 |
| Polycarbodiimide compound (C) | Type | C-1 | C-1 | | C-1 | C-1 | C-1 | C-1 | C-1 | C-1 | C-1 | C-1 |
| | Amount | 38 | 75 | | 38 | 38 | 38 | 38 | 38 | 38 | 38 | 38 |
| Hydrophobic solvent (E) | Type | E-1 | E-1 | E-1 | E-1 | E-1 | E-1 | E-1 | E-1 | E-1 | E-1 | E-1 |
| | Amount | 10 | 10 | 10 | 10 | 10 | 10 | 10 | 10 | 10 | 10 | 10 |

| | | | | | | | | | | | |
|---|---|---|---|---|---|---|---|---|---|---|---|
| Gel fraction (G₈₀) of the coating film after | 30 | 22 | 2 | 31 | 32 | 30 | 34 | 33 | 33 | 34 | 32 |
| being heated at 80° C. for 10 minutes [%] | | | | | | | | | | | |

### Production Example of Acrylic Resin Emulsion for Aqueous Base Coating Composition (Y)

### Production Example 69

A 130 part quantity of deionized water and 0.52 parts of “Aqualon KH-10” were placed into a reaction vessel equipped with a thermometer, a thermostat, a stirrer, a reflux condenser, a nitrogen inlet tube and a dropping funnel, stirred and mixed in a nitrogen flow, and heated to 80° C. Subsequently, 1% of the total amount of the emulsified monomer (1) described below and 5.3 parts of a 6% ammonium persulfate solution were introduced into the reaction vessel and maintained at 80° C. for 15 minutes. The remaining emulsified monomer (2) was then added dropwise into a reaction vessel over a period of 3 hours where the reaction vessel was maintained at the same temperature. After completion of the dropwise addition, the reaction product was aged for 1 hour. Subsequently, the emulsified monomer (3) described below was added dropwise over a period of 1 hour. After aging for 1 hour, the reaction product was cooled to 30° C. while gradually adding 40 parts of a 5% dimethylethanolamine solution into a reaction vessel, and filtrated using 100-mesh nylon cloth to obtain a filtrate of an acrylic resin emulsion having a mean particle diameter of 100 nm and a solids content of 30%.

The mean particle diameter was measured using the submicron particle size distribution analyzer (“COULTER N4”, produced by Beckman Coulter, Inc.) at 20° C.

The resulting acrylic resin had an acid value of 33 mg KOH/g and a hydroxy value of 25 mg KOH/g.

Emulsified monomer (2): 42 parts of deionized water, 0.72 parts of “Aqualon KH-10”, 2.1 parts of methylene-bis-acrylamide, 2.8 parts of styrene, 16.1 parts of methyl methacrylate, 28 parts of ethyl acrylate and 21 parts of n-butyl acrylate were mixed while stirring to obtain an emulsified monomer (2).

Emulsified monomer (3): 18 parts of deionized water, 0.31 parts of “Aqualon KH-10”, 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate and 9 parts of n-butyl acrylate were mixed while stirring to obtain an emulsified monomer (3).

### Production of Polyester Resin for Aqueous Base Coating Composition (Y)

### Production Example 70

A 109 part quantity of trimethylolpropane, 141 parts of 1,6-hexanediol, 126 parts of hexahydrophthalic anhydride and 120 parts of adipic acid were placed into a reaction vessel equipped with a thermometer, a thermostat, a stirrer, a reflux condenser and a water separator, and were heated from 160° C. to 230° C. over a period of 3 hours, followed by a condensation reaction at 230° C. for 4 hours. Subsequently, in order to add a carboxyl group to the resulting condensation reaction product, 38.3 parts of trimellitic anhydride was further added, and allowed to react at 170° C. for 30 minutes. The reaction product was diluted with 2-ethyl-1-hexanol (mass dissolved in 100 g of water at 20° C.: 0.1 g) to obtain a polyester resin solution with a solids content of 70%. The resulting polyester resin had an acid value of 46 mg KOH/g, a hydroxy value of 150 mg KOH/g, and a weight average molecular weight of 6,400.

### Production Example of Luster Pigment Dispersion

### Production Example 71

In a stirring and mixing container, 19 parts of an aluminium pigment paste (trade name “GX-180A”, produced by Asahi Kasei Metals Co., Ltd., metal content: 74%), 35 parts of 2-ethyl-1-hexanol, 8 parts of a phosphoric acid-containing resin solution (refer to Note 1 below) and 0.2 parts of 2-(dimethylamino)ethanol were homogeneously mixed to obtain a luster pigment dispersion.

Note 1: The phosphoric acid-containing resin solution was prepared as follows. A solvent mixture comprising 27.5 parts of methoxypropanol and 27.5 parts of isobutanol was put into a reaction vessel equipped with a thermometer, a thermostat, a stirrer, a reflux condenser, a nitrogen inlet tube and a dropping funnel, and then heated to 110° C. Subsequently, 121.5 parts of a mixture comprising 25 parts of styrene, 27.5 parts of n-butyl methacrylate, 20 parts of a branched higher alkyl acrylate (trade name: “isostearyl acrylate”, produced by Osaka Organic Chemical Industry, Ltd.), 7.5 parts of 4-hydroxybutyl acrylate, 15 parts of a phosphoric acid-containing polymerizable monomer (refer to Note 2 below), 12.5 parts of 2-methacryloyloxy ethyl acid phosphate, 10 parts of isobutanol and 4 parts of t-butyl peroxyoctanoate were added to the above solvent mixture over a period of 4 hours. Subsequently, a mixture comprising 0.5 parts of t-butyl peroxyoctanoate and 20 parts of isopropanol was added dropwise to the mixture obtained as above over a period of 1 hour. Subsequently, the resulting mixture was aged over a period of 1 hour while stirring to obtain a phosphoric acid-containing resin solution with a solids content of 50%. The phosphoric acid-containing resin had an acid value of 83 mg KOH/g based on the phosphoric acid group, a hydroxy value of 29 mg KOH/g, and a weight average molecular weight of 10,000.

Note 2: The phosphoric acid-containing polymerizable monomer was prepared as follows. 57.5 parts of monobutyl phosphate and 41 parts of isobutanol were put into a reaction vessel equipped with a thermometer, a thermostat, a stirrer, a reflux condenser, a nitrogen inlet tube and a dropping funnel, and were heated to 90° C. Subsequently, 42.5 parts of glycidyl methacrylate was added dropwise over a period of 2 hours. After aging for 1 hour while stirring, 59 parts of isopropanol was added to obtain a phosphoric acid-containing polymerizable monomer solution with a solids content of 50%. The resulting monomer had an acid value of 285 mg KOH/g based on the phosphoric acid group.

### Production of Aqueous Base Coating Composition (Y)

### Production Example 72

A 100 part quantity of the acrylic resin emulsion obtained in Production Example 69, 57 parts of the polyester resin solution obtained in Production Example 70, 62 parts of the luster pigment dispersion obtained in Production Example 71 and 37.5 parts of the melamine resin (trade name “Cymel 325”, produced by Japan Cytec Industries, Inc., solids content: 80%) were homogeneously mixed, and a polyacrylic acid thickening agent (trade name “Primal ASE-60”, produced by Rohm and Haas), 2-(dimethylamino)ethanol and deionized water were further added to obtain an aqueous base coating composition (Y-1) having a pH of 8.0, a solids content of 25%, and a viscosity of 40 seconds as measured at 20° C. using Ford Cup No. 4.

### Preparation of Test Plate

The aqueous intermediate coating compositions (X-1) to (X-41) obtained in Production Examples 28 to 68, and the aqueous base coating composition (Y-1) obtained in Production Example 72 were used in the following manner to form test plates. Evaluation tests were then performed.

### Preparation of Test Substrate to be Coated

A cationic electrodeposition coating composition (trade name “Electron GT-10”, produced by Kansai Paint Co., Ltd.) was applied to a cold-rolled steel plate treated with zinc phosphate by electrodeposition to a cured film thickness of 20 um, and was cured by heating at 170° C. for 30 minutes. A test substrate to be coated was thus prepared.

### Example 1

The aqueous intermediate coating composition (X-1) obtained in Production Example 28 was electrostatically applied to the substrate to a cured film thickness of 25 μm using a rotary atomizing electrostatic coating machine. The substrate was then allowed to stand for 2 minutes, and preheated at 80° C. for 8 minutes. Subsequently, the aqueous base coating composition (Y-1) obtained in Production Example 72 was electrostatically applied to the uncured intermediate coating film to a cured film thickness of 15 μm using a rotary atomizing electrostatic coating machine, then allowed to stand for 2 minutes, and preheated at 80° C. for 3 minutes. Next, an acrylic resin solvent-based clear topcoat composition (trade name “Magicron KINO-1210”, produced by Kansai Paint Co., Ltd.; hereinafter sometimes referred to as “clear coating composition (Z-1)”) was electrostatically applied to the uncured base coating film to a cured film thickness of 35 μm, then allowed to stand for 7 minutes, and heated at 140° C. for 30 minutes to cure the intermediate coating film, thus obtaining a test plate.

### Examples 2 to 30 and Comparative Examples 1 to 11

Test plates were obtained in the same manner as in Example 1, except that any one of the aqueous intermediate coating compositions (X-2) to (X-41) shown in Table 4 was used in place of the aqueous intermediate coating composition (X-1) obtained in Production Example 21.

### Evaluation Test

Test plates obtained in Examples 1 to 30 and Comparative Examples 1 to 11 were evaluated according to the test method below. Table 4 shows the evaluation results.

### Test Method

Smoothness: Smoothness was evaluated based on the Long Wave (LW) values that were measured by “Wave Scan” (produced by BYK Gardner). The smaller the Long Wave (LW) value, the smoother the coating surface. Generally, a coating composition applied to automobile bodies and the like must have a Long Wave value of 10 or less.

Distinctness of image: Distinctness of image was evaluated based on the Short Wave (SW) values measured by the “Wave Scan”. The smaller the Short Wave (SW) value, the higher the distinctness of image on the coating surface. Generally, a coating composition applied to automobile bodies and the like must have a Short Wave value of 16 or less.

Water resistance: Test plates were immersed in warm water at 40° C. for 240 hours and removed therefrom, and then dried at 20° C. for 12 hours. Lattice-like cuts were made in the multilayer coating films on the test plates in a manner such that a knife reaches the base material, making 100 crosscuts having a size of 2 mm×2 mm. Subsequently, an adhesive cellophane tape was adfixed to their surfaces, and the tape was abruptly peeled off at 20° C. The conditions of the remaining crosscut coating films were checked.

A: 100 crosscut sections of the coating film remained, and no small chipped edges were produced at the cutting edges made by the cutter knife;

B: 100 crosscut sections of the coating film remained, but small chipped edges were observed at the cutting edges made by the cutter knife;

C: 90 to 99 crosscut sections of the coating film remained; and

D: The number of remaining crosscut sections of the coating film was 89 or less.

Chipping resistance: A test plate was fixed on the sample holder of a gravel chipping test instrument (trade name “JA-400”, produced by Suga Test Instruments Co., Ltd.,) and 50 g of granite gravel of No. 7 particle size was sprayed at a distance of 30 cm from the test plate and at an angle of 45° onto the test plate with compressed air at 0.392 MPa (4 kgf/cm²) at −20° C. Subsequently, the resulting test plate was washed with water and dried. A cloth adhesive tape (produced by Nichiban Co., Ltd.) was applied to the coating surface, and then peeled off. The degree of the occurrence of the scratches formed on the coating film was visually observed and evaluated.

A: Sizes of scratches were exceedingly small, and the electrodeposition surface and the substrate of the steel plate were not exposed.

B: Sizes of scratches were small, and the electrodeposition surface and the substrate of the steel plate were not exposed.

C: Sizes of scratches were small, but the electrodeposition surface or the substrate of the steel plate was exposed.

D: Sizes of scratches were considerably large, and the substrate of the steel plate was largely exposed.

### Total Evaluation:

In the field in which the present invention pertains, it is important for the coating film to have excellent smoothness, distinctness of image, water resistance, and chipping resistance. Accordingly, a total evaluation was made based on the following criteria:

A: Having a smoothness of 10 or less, distinctness of image of 16 or less, and both water resistance and chipping resistance evaluated as A

B: Having a smoothness of 10 or less, distinctness of image of 16 or less, water resistance and chipping resistance evaluated as A or B, and either water resistance or chipping resistance evaluated as B

C: Having a smoothness of 10 or less, distinctness of image of 16 or less, water resistance and chipping resistance evaluated as C, B or A, and either water resistance or chipping resistance evaluated as C

D: Having a smoothness of greater than 10, distinctness of image of greater than 16, or at least one of the water resistance and the chipping resistance evaluated as D.

TABLE 4

| | | Aqueous | Aqueous | | | | | | |
|---|---|---|---|---|---|---|---|---|---|
| | | intermediate | base | Clear | | | | | |
| | | coating | coating | coating | Evaluation result | | | | |
| | | composition | composition | composition | | Distinctness | Water | Chipping | |
| | | (X) | (Y) | (Z) | Smoothness | of image | resistance | resistance | Total evaluation |
| Example | 1 | X-1 | Y-1 | Z-1 | 6.2 | 11.9 | A | B | B |
| | 2 | X-2 | Y-1 | Z-1 | 6.7 | 10.9 | A | A | A |
| | 3 | X-3 | Y-1 | Z-1 | 7.3 | 15.3 | B | B | B |
| | 4 | X-4 | Y-1 | Z-1 | 7.9 | 15.9 | A | B | B |
| | 5 | X-5 | Y-1 | Z-1 | 7.6 | 13.5 | B | B | B |
| | 6 | X-6 | Y-1 | Z-1 | 7.3 | 10.8 | A | A | A |
| | 7 | X-7 | Y-1 | Z-1 | 8.6 | 12.5 | A | B | B |
| | 8 | X-8 | Y-1 | Z-1 | 7.2 | 12.5 | A | B | B |
| | 9 | X-9 | Y-1 | Z-1 | 6.9 | 11.9 | B | A | B |
| | 10 | X-10 | Y-1 | Z-1 | 7.7 | 13.3 | B | A | B |
| | 11 | X-11 | Y-1 | Z-1 | 7.5 | 13.1 | A | A | A |
| | 12 | X-12 | Y-1 | Z-1 | 7.1 | 12.7 | A | B | B |
| | 13 | X-13 | Y-1 | Z-1 | 6.9 | 11.2 | A | A | A |
| | 14 | X-14 | Y-1 | Z-1 | 7.9 | 13.6 | A | A | A |
| | 15 | X-15 | Y-1 | Z-1 | 7.3 | 12.0 | A | B | B |
| | 16 | X-16 | Y-1 | Z-1 | 7.8 | 13.8 | A | B | B |
| | 17 | X-17 | Y-1 | Z-1 | 6.6 | 10.4 | A | A | A |
| | 18 | X-18 | Y-1 | Z-1 | 7.4 | 10.1 | A | A | A |
| | 19 | X-19 | Y-1 | Z-1 | 6.6 | 10.8 | A | A | A |
| | 20 | X-20 | Y-1 | Z-1 | 7.1 | 11.3 | A | A | A |
| | 21 | X-21 | Y-1 | Z-1 | 6.4 | 10.7 | A | A | A |
| | 22 | X-22 | Y-1 | Z-1 | 7.8 | 10.8 | A | A | A |
| | 23 | X-23 | Y-1 | Z-1 | 8.1 | 10.4 | A | A | A |
| | 24 | X-24 | Y-1 | Z-1 | 6.4 | 9.6 | A | A | A |
| | 25 | X-25 | Y-1 | Z-1 | 6.5 | 9.9 | A | A | A |
| | 26 | X-26 | Y-1 | Z-1 | 6.6 | 10.4 | A | A | A |
| | 27 | X-27 | Y-1 | Z-1 | 6.5 | 10.0 | B | B | B |
| | 28 | X-28 | Y-1 | Z-1 | 6.4 | 9.8 | B | A | B |
| | 29 | X-29 | Y-1 | Z-1 | 6.5 | 9.8 | B | B | B |
| | 30 | X-30 | Y-1 | Z-1 | 6.6 | 10.2 | B | A | B |
| Comparative | 1 | X-31 | Y-1 | Z-1 | 10.8 | 16.9 | B | C | D |
| Example | 2 | X-32 | Y-1 | Z-1 | 8.1 | 13.5 | B | D | D |
| | 3 | X-33 | Y-1 | Z-1 | 9.7 | 22.3 | A | C | D |
| | 4 | X-34 | Y-1 | Z-1 | 6.1 | 10.7 | B | C | C |
| | 5 | X-35 | Y-1 | Z-1 | 7.5 | 12.1 | C | B | C |
| | 6 | X-36 | Y-1 | Z-1 | 7.7 | 18.5 | A | B | D |
| | 7 | X-37 | Y-1 | Z-1 | 8.1 | 19.2 | C | B | D |
| | 8 | X-38 | Y-1 | Z-1 | 9.3 | 21.0 | B | C | D |
| | 9 | X-39 | Y-1 | Z-1 | 14.4 | 12.4 | A | A | D |
| | 10 | X-40 | Y-1 | Z-1 | 10.9 | 18.5 | A | A | D |
| | 11 | X-41 | Y-1 | Z-1 | 8.6 | 15.3 | A | C | C |

1. A method of forming a multilayer coating film comprising the steps of:
(1) applying an aqueous intermediate coating composition (X) to a substrate to form an intermediate coating layer thereon;
(2) applying an aqueous base coating composition (Y) to the uncured intermediate coating layer formed in step (1) to form a base coating layer thereon;
(3) applying a clear coating composition (Z) to the uncured base coating layer formed in step (2) to form a clear coating layer thereon; and
(4) simultaneously heat-curing the uncured intermediate coating, uncured base coating, and uncured clear coating layers formed in steps (1) to (3);
the aqueous intermediate coating composition (X) comprising: as a resin component;
a hydroxy- and carboxy-containing polyester resin (A) having a hydroxy value in the range of 60 to 200 mgKOH/g, an acid value in the range of 10 to 60 mgKOH/g, and a number average molecular weight in the range of 700 to 5,000; a melamine resin (B) having a weight average molecular weight in the range of 500 to 4,000; and a polycarbodiimide compound (C).

2. The method of forming a multilayer coating film according to claim 1 wherein the hydroxy- and carboxy-containing polyester resin (A) is a polyester resin containing a C₄ or higher linear alkylene group in an amount of 0.3 to 2.5 mol/kg (on a resin solids basis).

3. The method of forming a multilayer coating film according to claim 1 wherein the hydroxy- and carboxy-containing polyester resin (A) contains a benzene ring and/or a cyclohexane ring in such an amount that the total amount of benzene ring and cyclohexane ring is in the range of 1.5 to 4.0 mol/kg (on a resin solids basis).

4. The method of forming a multilayer coating film according to claim 1 wherein the melamine resin (B) is a methyl-butyl mixed etherified melamine resin having a methoxy/butoxy molar ratio in the range of 95/5 to 5/95.

5. The method of forming a multilayer coating film according to claim 1 wherein the aqueous intermediate coating composition (X) contains a hydroxy- and carboxy-containing polyester resin (A), a melamine resin (B), and a polycarbodiimide compound (C) in such proportions that the amount of hydroxy- and carboxy-containing polyester resin (A) is 5 to 95 parts by mass, the amount of melamine resin (B) is 2 to 60 parts by mass, and the amount of polycarbodiimide compound (C) is 2 to 60 parts by mass, per 100 parts by mass of the total amount of the hydroxy- and carboxy-containing polyester resin (A), the melamine resin (B) and the polycarbodiimide compound (C), on a solids basis.

6. The method of forming a multilayer coating film according to claim 1 wherein the aqueous intermediate coating composition (X) contains a coloring pigment (D1) and/or an extender pigment (D2) in such an amount that the total amount of coloring pigment (D1) and extender pigment (D2) is in the range of 40 to 300 parts by mass, per 100 parts by mass of the total amount of hydroxy- and carboxy-containing polyester resin (A), melamine resin (B) and polycarbodiimide compound (C), on a solids basis.

7. The method of forming a multilayer coating film according to claim 1 wherein the aqueous intermediate coating composition (X) further contains an acrylic resin.

8. The method of forming a multilayer coating film according to claim 1 wherein the aqueous base coating composition (Y) comprises a luster pigment (D3).

9. The method of forming a multilayer coating film according to claim 1 wherein the substrate is a vehicle body having an undercoating layer formed thereon using an electrodeposition coating composition.

10. An aqueous intermediate coating composition comprising a hydroxy- and carboxy-containing polyester resin (A) having a hydroxy value in the range of 60 to 200 mgKOH/g, an acid value in the range of 10 to 60 mgKOH/g, and a number average molecular weight in the range of 700 to 5,000, a melamine resin (B) having a weight average molecular weight in the range of 500 to 4,000, and a polycarbodiimide compound (C).

11. An article having a multilayer coating film formed thereon by the method of claim 1.

12. The method of forming a multilayer coating film according to claim 2 wherein the aqueous intermediate coating composition (X) contains a hydroxy- and carboxy-containing polyester resin (A), a melamine resin (B), and a polycarbodiimide compound (C) in such proportions that the amount of hydroxy- and carboxy-containing polyester resin (A) is 5 to 95 parts by mass, the amount of melamine resin (B) is 2 to 60 parts by mass, and the amount of polycarbodiimide compound (C) is 2 to 60 parts by mass, per 100 parts by mass of the total amount of the hydroxy- and carboxy-containing polyester resin (A), the melamine resin (B) and the polycarbodiimide compound (C), on a solids basis.

13. The method of forming a multilayer coating film according to claim 3 wherein the aqueous intermediate coating composition (X) contains a hydroxy- and carboxy-containing polyester resin (A), a melamine resin (B), and a polycarbodiimide compound (C) in such proportions that the amount of hydroxy- and carboxy-containing polyester resin (A) is 5 to 95 parts by mass, the amount of melamine resin (B) is 2 to 60 parts by mass, and the amount of polycarbodiimide compound (C) is 2 to 60 parts by mass, per 100 parts by mass of the total amount of the hydroxy- and carboxy-containing polyester resin (A), the melamine resin (B) and the polycarbodiimide compound (C), on a solids basis.

14. The method of forming a multilayer coating film according to claim 4 wherein the aqueous intermediate coating composition (X) contains a hydroxy- and carboxy-containing polyester resin (A), a melamine resin (B), and a polycarbodiimide compound (C) in such proportions that the amount of hydroxy- and carboxy-containing polyester resin (A) is 5 to 95 parts by mass, the amount of melamine resin (B) is 2 to 60 parts by mass, and the amount of polycarbodiimide compound (C) is 2 to 60 parts by mass, per 100 parts by mass of the total amount of the hydroxy- and carboxy-containing polyester resin (A), the melamine resin (B) and the polycarbodiimide compound (C), on a solids basis.
